(19) United States
(12) Patent Application Publication
(10) Pub. No.: US 2015/0365003 A1
(43) Pub. Date: Dec. 17, 2015

(54) Power Conversion System

(71) Applicant: Laurence P. Sadwick, Salt Lake City, UT (US)

(72) Inventor: Laurence P. Sadwick, Salt Lake City, UT (US)

(21) Appl. No.: 14/738,758

(22) Filed: Jun. 12, 2015

Related U.S. Application Data
(60) Provisional application No. 62/011,501, filed on Jun. 12, 2014.

(51) Int. Cl. H02M 3/335

(52) U.S. Cl. CPC H02M 3/33507

(57) ABSTRACT

A power conversion system includes a power input, a power output, and a number of stackable power conversion modules having inputs connected to the power input and outputs connected to the power output, each including a transformer switched at a higher frequency than a grid frequency.

### BACKGROUND

Many developed regions of the world have well established power grids that typically transmit power using alternating current (AC). However, renewable energy sources such as solar photovoltaic panels which generate power in direct current (DC) form are becoming more common, and interest is increasing in grid-tied storage systems which store and transfer power in DC form. Such DC systems are not directly compatible with AC power grids, and it may not be feasible to change large portions of the power grid to DC. Conversion systems between DC and AC power are therefore becoming more important to interconnect DC and AC power systems, such as, but not limited to, grid-tied storage systems. Smaller grids, sometimes referred to as micro-grids, are also becoming more popular as well as small micro-grids to control, monitor, analyze, allocate, etc. at the building levels and for groups and clusters buildings and associated facilities to transfer energy and power in a bidirectional manner.

### SUMMARY

Various embodiments of the present invention provide power conversion systems between direct current (DC) power and alternating current (AC) power or from AC to DC or from AC to AC or DC to DC that can be used, for example, in grid-tied energy storage systems as well as any other systems or applications which can benefit from conversion between DC and AC power and vice versa.

The embodiments shown and discussed are intended to be examples of the present invention and in no way or form should these examples be viewed as being limiting of and for the present invention.

This summary provides only a general outline of some embodiments of the invention. The phrases “in one embodiment,” “according to one embodiment,” “in various embodiments”, “in one or more embodiments”, “in particular embodiments” and the like generally mean the particular feature, structure, or characteristic following the phrase is included in at least one embodiment of the present invention, and may be included in more than one embodiment of the present invention. Importantly, such phrases do not necessarily refer to the same embodiment. Additional embodiments are disclosed in the following detailed description, the appended claims and the accompanying drawings.

### BRIEF DESCRIPTION OF THE FIGURES

A further understanding of the various embodiments of the present invention may be realized by reference to the Figures which are described in remaining portions of the specification. In the Figures, like reference numerals may be used throughout several drawings to refer to similar components.

FIG. 1 depicts a block diagram of a power conversion system in accordance with some embodiments of the invention;

FIG. 2 depicts a schematic diagram of a stackable switching module in accordance with some embodiments of the invention;

FIG. 3 depicts a schematic diagram of a stackable switching module with a DC output in accordance with some embodiments of the invention;

FIG. 4 depicts a block diagram of a power conversion system in accordance with some embodiments of the invention;

FIG. 5 depicts a block diagram of a power conversion system with multi-phase output in accordance with some embodiments of the invention;

FIG. 6 depicts a block diagram of a power conversion system with digital controller in accordance with some embodiments of the invention;

FIG. 7 depicts a block diagram of an example solid state circuit protection (SSCP) circuit for a power conversion system in accordance with some embodiments of the invention;

FIG. 8 depicts a block diagram of a power conversion system with selectable AC/DC in, AC/DC out in accordance with some embodiments of the invention;

FIG. 9 depicts a block diagram of a power conversion system with selectable AC/DC in, AC/DC out and DC voltage input stage with optional EMI filter elements in accordance with some embodiments of the invention;

FIG. 10 depicts a block diagram of a power conversion system with selectable AC/DC in, AC or DC out with optional EMI filter elements in accordance with some embodiments of the invention;

FIG. 11 depicts a block diagram of a power conversion system with selectable AC/DC in with universal AC voltage input stage, with AC or DC out in accordance with some embodiments of the invention;

FIG. 12 depicts a block diagram of a voltage balance detector in accordance with some embodiments of the invention;

FIG. 13 depicts a double-ended voltage balance detector in accordance with some embodiments of the invention;

FIG. 14 depicts a block diagram of a stackable high voltage module in accordance with some embodiments of the invention;

FIG. 15 depicts a block diagram of a power conversion system with stackable switching modules and voltage control feedback in accordance with some embodiments of the invention;

FIG. 16 depicts a block diagram of an AC input power conversion system with 3 phase AC output in accordance with some embodiments of the invention; and

FIG. 17 depicts a block diagram of a DC input power conversion system with 3 phase AC output in accordance with some embodiments of the invention.

### DETAILED DESCRIPTION OF THE INVENTION

A typical power conversion design for use, for example, in grid-tied energy storage applications involves a direct current to direct current (DC to DC) converter front end followed by a direct current to alternating current (DC to AC) inverter back end that interconnects with the electric utility grid via one or more large, bulky and relatively expensive 60 Hz transformers. It is highly desirable for a number of reasons to be able to replace the bulky 60 Hz (or 50 Hz or other low frequencies such as 400 Hz) transformers with smaller, inexpensive, flexible transformers for higher frequency operation that in some embodiments enable additional capabilities and features.

Although silicon-based power conversion technologies including ones incorporating field effect transistors (FETs) and insulated gate bipolar transistors (IGBTs), other devices such as, but not limited to, silicon carbide (SiC)-based power devices and gallium nitride (GaN) power devices can be used in power conversion systems and can provide beneficial characteristics in high frequency and high density power conversion designs. By providing low on-resistance and low gate charges due to high electron mobility, SiC and/or GaN devices can significantly reduce switching losses and allow for higher switching frequencies resulting in high power density power conversion designs. However in certain applications it still may be useful or advantageous to utilize silicon (Si)-based devices including power devices.

SiC- and GaN-based devices, including diodes and field effect transistors (FETs), can be used for a high frequency link converter design approach to improve grid-tied energy storage applications. Some embodiments of a high frequency link converter include implementations of GaN-based high frequency link converter systems that use GaN-based devices for, among other things, the DC to DC converters and/or the DC to AC inverters of the high frequency link converter systems. The properties and specifications of the GaN-based high frequency link converter can include, for example: greater than 600 V DC-link voltage and upwards in the kV and higher kV range; greater than 50 kW power; a 480 VAC three phase output; SiC and/or GaN-based semiconductor continuous junction temperatures considerably higher than ambient temperatures, a high frequency link frequency of greater than 15 kHz and, in some cases, greater than 100 kHz or even into the MHz range; and an overall efficiency of greater than 97%. In addition, the implementations are both compact and cost-efficient.

Grid-tied energy storage systems are a key subsystem to the electric utility infrastructure in that they provide multiple technical and economic benefits such as, but not limited to, increasing asset utilization and deferring upgrades of the grid, providing flexibility for the customer, providing cost control, maintaining power quality, and increasing the value of variable renewable generation from photovoltaic, solar including solar heating, concentrating (concentrators) and focusing and wind generation systems. Such systems can improve the flexibility, reliability, security, quality, and cost effectiveness of the existing and future electric utility systems. Current energy storage systems including the power conversion system can be packaged in standard shipping containers for the ease of transportability and siting. They are attractive at least because they have lower installation cost and less installation time to operation. The adoption, incorporation and use of the grid link DC to DC converters, AC to AC converters, AC to DC converters, and DC to AC inverters including bidirectional ones disclosed herein support and permit lower energy installation costs and simpler implementations and maintenance. These and other benefits result in lower costs to customers and lower cost of ownership with increased flexibility, material utilization, reliability, size and other positive benefits to utilities, customers, society and to the public. The use in some embodiments of SiC or GaN-based devices can further increase efficiencies, reduce size, weight and cost and reduce dependency on non-domestic sources of energy.

Wide band gap (WBG) devices such as SiC and GaN are used in some embodiments for switch mode power supply applications. These wide bandgap materials offer the potential for higher switching frequencies, higher blocking voltages, lower switching losses and a higher junction temperature than traditional silicon-based switches, which can result in higher power density than silicon-based system and is thus an attractive approach for containerized energy storage systems.

The present invention includes but is not limited to DC to DC link converters, inverters and related electronics. Such DC to DC link systems can provide, at a minimum, greater than 600 V DC-link voltage and into the high(er) kV; greater than 50 kW power which can be increased to higher power levels well into for example the high 100s of kilowatts or even higher by combining additional modules; and a 480 VAC three phase output as well as also allowing for other outputs including DC outputs. In some embodiments of the present invention, both AC and DC including multi-phase (i.e., 3 phase) and DC outputs are made available for use.

Embodiments of the present invention can include power supply modules that are designed to deliver floating multi-kilowatt output power and are fully protected including protected against arcs, shorts, over voltage, over current and over temperature. The high voltage power supplies are extremely efficient and can be either (or both) analog or digitally controlled and also allow for bidirectional power transfer and use and can also support cybersecurity.

Embodiments of the present invention can include wired and wireless control, monitoring and data logging of the power converters and inverters including thermal monitoring, control and management including thermal monitoring, control and management and approaches and strategies.

The present invention uses transistors to drive switching to a number of smaller, higher frequency (i.e., 15 kHz or higher) transformers to provide a higher paralleled output power that can be increased in a linear fashion to tens of thousands to hundreds of thousands of watts (i.e., to 10 kW to 100s of kW) of output power. The low switching losses and on-resistance switching of such systems enables efficient, compact power converters, inverters and associated power supplies with high power density.

The transformers for the DC to DC conversion are adapted to handle and support high voltage isolation and can, for example, but not limited to, provide step-up in one direction and step down in the other. The power handling capabilities per transformer depend on the construction and type of transformer as well as the switching frequency. For a given transformer design, the power handling and power level increases in a roughly linear manner as the switching frequency increases. Thus, as an example only, if 50 kW power transfer is needed and, for example, 4 transformers are required to provide the 50 kW power transfer, then, instead, if 100 kW is needed, 8 transformers will be required. Again, the size of the transformers depends primarily on the switching frequency and the output power level. If the frequency were to be doubled, then roughly approximately twice as much power could be handled for these examples listed directly above and below thus allowing either approximately half the number of transformers and associated modules or twice the power that the modules can handle. The present invention also provides isolated (for example up to 50 kV) power directly from the primaries of these transformers which are powered by, for example, either AC line to DC or DC to DC buck converter stages to all of the secondaries of the high voltage transformers. This isolation method also allows for fast and high data rate communications between the true ground and local ground(s). This allows any or all of the power train to essentially float.

The transistors that provide switching to a number of small transformers to provide a higher series output voltage that can be increased in a linear fashion to tens of thousands of volts. Higher frequency switching components support efficient and compact power conversion and power density in high voltage power supplies and modulators.

Some embodiments of the present invention can use voltage doublers or triplers or higher multipliers on the secondaries of the transformers which allows each transformer to handle typically 5000 to 8000 Volts each; thus if 20 kV is needed then typically 3 to 4 transformers are used; if 40 kV is needed then 5 to 8 transformers are used; if 50 kV is needed, then 7 to 10 transformers are typically used. The size of the transformers depend primarily on the switching frequency and the output power level—as an example, a conservative design might be about 8 kW per board (module). Isolated (e.g., up to 50 kV) power is provided directly from the primaries of these transformers which can be powered by AC line or DC to DC buck converter stages to all of the secondaries of the high voltage transformers. This isolation method also allows fast and high data rate communications between the true ground and cathode ground so that devices and interfaces that are typically referenced from ground can be connected to the implementations of the present invention. Again the size of each of the high voltage transformers depends on a number of factors with one of the most important being the switching frequency of the buck or other (e.g., buck-boost, boost, boost-buck, cascaded buck and boost, flyback, forward converter, Cuk, SEPIC, etc,) converter as well as, for example, the power to be converted, transferred, etc.

In some embodiments of the present invention, SiC or GaN-based transistors may enable high frequency (high density) operation of, for example, a boost/power factor corrected (PFC) power supply that can have a 70% loss reduction compared to silicon transistors. Some embodiments of these modules with integrated filters that for example filter out higher harmonics of the switching frequency show enhanced electromechanical efficiency when providing power to, for example, motors by making the motors more efficient by using pure sinusoidal drive signals. Some embodiments of the present invention include power inverters with compact filters incorporated on the same printed circuit board as the inverter circuit.

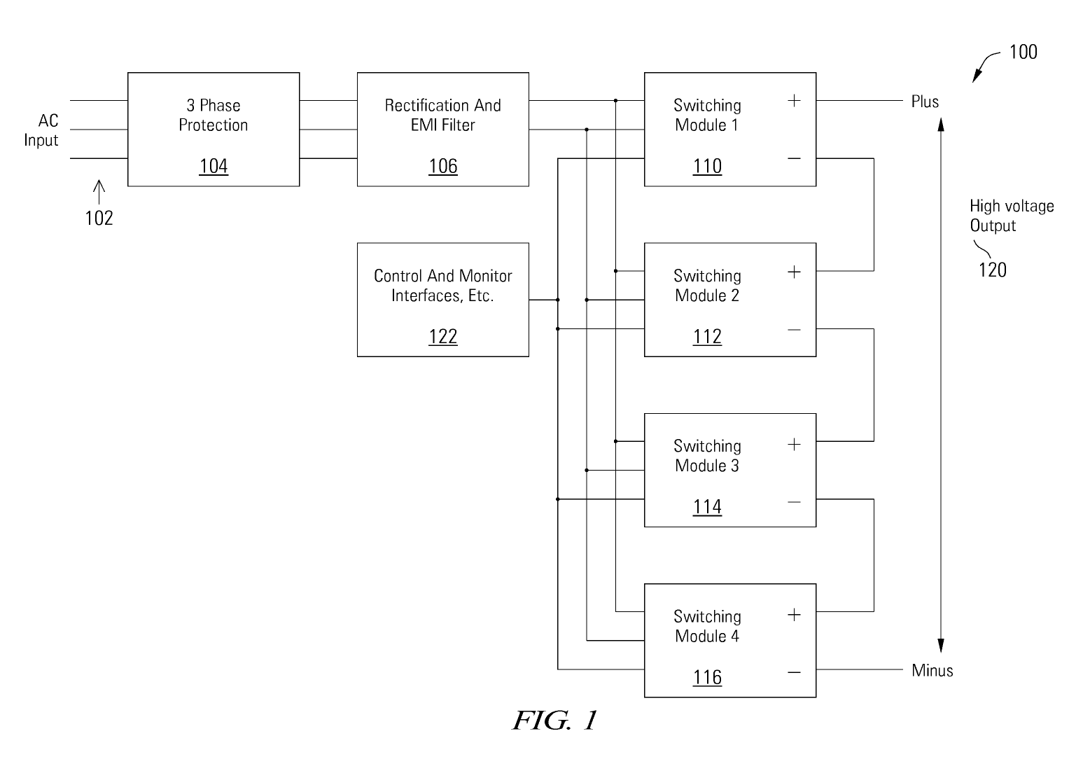

Turning now to FIG. 1, a block diagram of a power conversion system 100 is depicted in accordance with some embodiments of the invention. The power conversion system 100 can include any number of stackable switching modules (e.g., 110, 112, 114, 116) in order to provide the desired power handling capability and output power. The power conversion system 100 is not limited to use with any particular type of input, and can be AC input including, but not limited to, single phase or multi-phase inputs, or can be a DC input, switchable or selectable inputs, can have any desired input frequency, voltage, current, etc.

In some embodiments, as in FIG. 1, a three-phase AC input 102 is received and is processed by a 3 phase protection circuit 104, which provides any suitable and desired protection functions, such as, but not limited to, arc protection, short circuit protection, changing duty cycle, single and multiple arc detects before trip, fault clear condition(s) before reset, automatic reset, hiccup mode, etc. These can be used to determine fault conditions including ground isolation fault (GIF), single and double (catastrophic) GIF, under-voltage, over-voltage, over-current, over-temperature, reverse voltage, direct shorts, dI/dt faults, dV/dt faults, interlinks and interlocks detection, etc.

The three phase power (or other power input, in other embodiments) is rectified in a rectification circuit 106, and, optionally, EMI filtering is provided. Rectification can be performed in any desired manner, using either or both passive and active components, which can be stacked or arranged in any suitable manner to provide the needed voltage and/or current and/or power handling.

Switching modules 110, 112, 114, 116 perform power conversion using transistors to drive switching to a number of smaller, higher frequency (i.e., 15 kHz or higher) transformers to provide a higher paralleled output power 120 that can be increased in a linear fashion to tens of thousands to hundreds of thousands of watts (i.e., to 10 kW to 100s of kW) of output power. The present invention can use, for example, but not limited to, boost, push-pull and forward converter, half- and full-bridge, flyback, Cuk, etc. for both current-mode and current-fed, etc. combinations of these, topologies, etc. In some embodiments, optional control and monitor interfaces/circuits 122 can be included to control power conversion, control output power/voltage/current, monitor input and output power/voltage/current characteristics, internal circuit performance, error detection/handling/reporting, etc. For example, optional control and monitor interfaces/circuits 122 can identify and report faulty modules so that the system can be repaired, or so that optional off-line redundant modules can be automatically switched in and faulty modules switched out, etc.

Information of any type can be communicated between switching modules (e.g., 110, 112, 114, 116) in any suitable manner and for any suitable purpose, such as, but not limited to, using wireless (e.g., ZigBee, IEEE 802, WiFi, Bluetooth, Bluetooth Low Energy, Zwave, cellular communications, RF, microwave, optical, etc.), wired (e.g., Ethernet, USB, etc.) or powerline communications. Such communication can support, for example but not limited to, remote control and monitoring, status exchange, alarms, commands, configuration information, balancing information, scheduling, etc. In addition information of any type may also be communicated to/from other groups of modules that form a system including a micro or mini grid system including groups and clusters of such systems whether very near or very far between one or more members of the groups, clusters, etc. and other local (near) or remote locations (far) by any technique, technology, approach, method, etc.

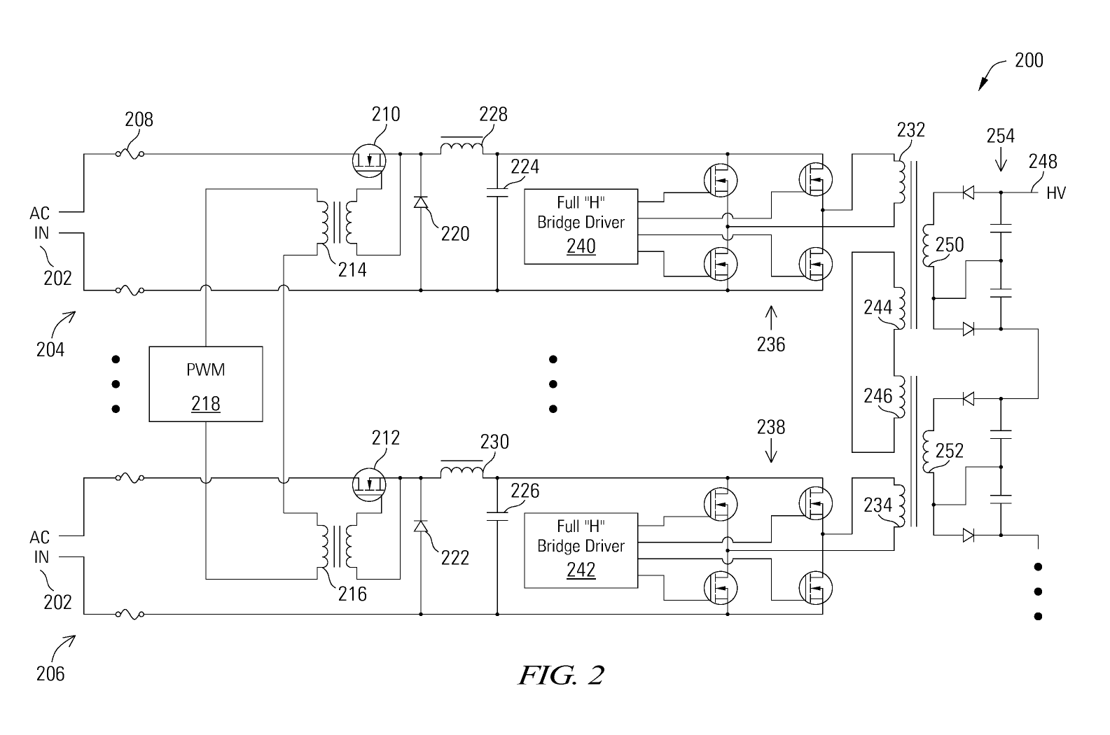

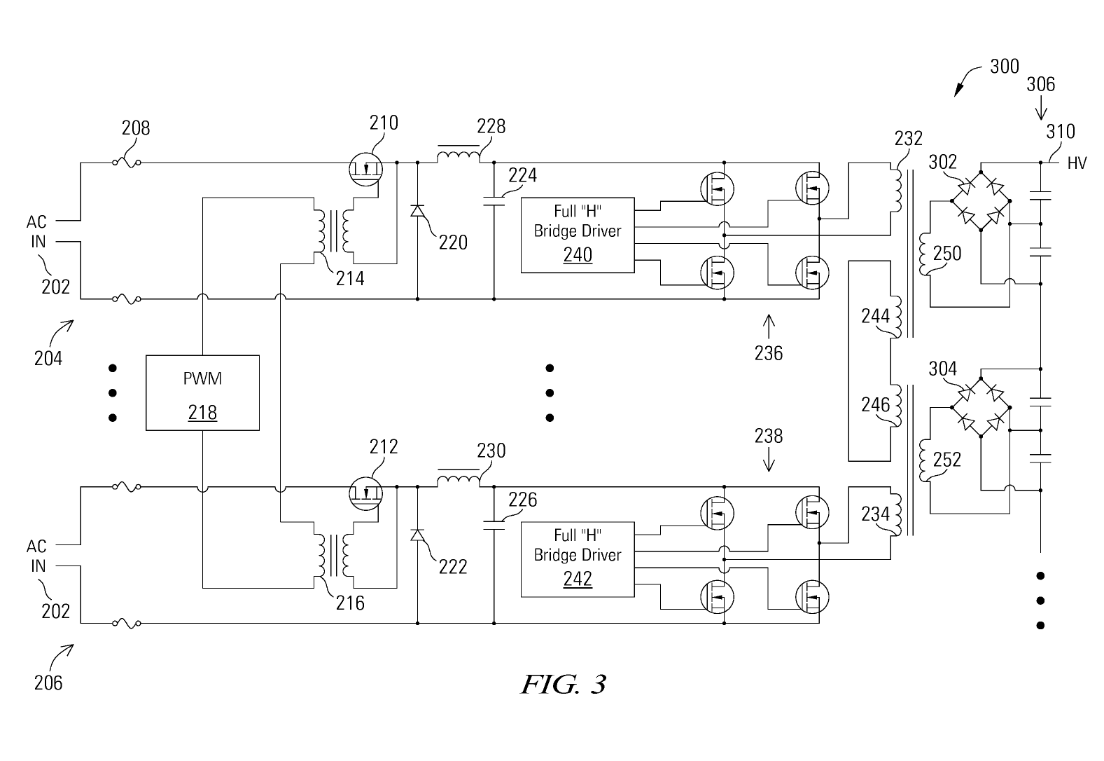

Turning now to FIG. 2, a schematic diagram of a stackable switching module 200 is depicted in accordance with some embodiments of the invention. The output power of the stackable switching module (e.g., 200) is based at least in part on the size of the board and the switching frequency. For example, an 8 kW switching module incorporated into a “six pack” of 8 kW modules is capable of producing a 48 kW output. Three such modules combine to produce approximately 150 kW. Four such modules combined in series could provide approximately 200 kW. Please note that these switching modules do not necessarily need to be high voltage potted in any way or form. If potting were to be used, the size of the switching module boards would significantly decrease even if power MOSFETs were still used. Employing SiC or GaN-based FETs allows substantial reduction in the size of switching modules while simultaneously increasing the power handling capability. All boards and modules can be integrated into a single system in a single housing with user-easy-to replace plug-in modules and boards. The stackable switching module approach is highly flexible. In some implementations, due to the design and high efficiency of the switching modules only simple air cooling is typically needed for the modular power supplies even under maximum operating power conditions. The power supply technology/topology can use phase-shifted full bridge quasi-resonant switching for high efficiency and low noise. As an example, if the input is 480 VAC then the two sections of MOSFET switching shown in FIG. 1 can be used in series. For running on 240 VAC, the two sections of the GaN-based FET switching shown in FIGS. 1-3 can be used in parallel (note that the filter and other associated components and circuits are not shown in FIGS. 2 and 3). The choice of 480 VAC or 240 VAC can be user selectable or can be automatically performed. In some embodiments, switching modules include connections to select either input voltage. In other embodiments, the AC input voltage can be higher than 480 VAC including much higher than 480 VAC and well into the kV regime.

An AC input 202 is connected to each of the stacked MOSFET switching sections 204, 206 through optional fuses (e.g., 208) to GaN-based FETs 210, 212 or other switches. The switches 210, 212 are driven through isolating transformers 214, 216 by a relatively high frequency pulse generator 218, pulse width modulator, oscillator of any type, or other circuit that can control the switches 210, 212, generally at a higher or much higher frequency than the grid frequency or other frequency of the AC input 202. As a non-limiting example, the AC input 202 may have a frequency of 50 Hz, 60 Hz, or even up to several hundred Hz, whereas the pulse generator 218 may have a frequency on the order of 100 kHz. Note that although 100 kHz is mentioned here, the frequency could be higher or lower, preferably higher and into the MHz range or higher. In some embodiments, the PWM phases between the gates of the high frequency switching FETs can be different, for example, by half a cycle (i.e., 180 degrees if two, 120 degrees if 3, etc.) to reduce ripple and aid in maintaining high power factor.

A diode (e.g., 220, 222) and a capacitor (e.g., 224, 226) can be connected across the switched input. An inductor (e.g., 228, 230) can be connected in series in the switched input line, comprising in some embodiments the secondary windings of gate-driven transformers controlled by a control circuit (not shown).

Bi-directional power flow through output transformers (e.g., 232, 234) can be provided using H-bridges (e.g., 236, 238) controlled by H-bridge drivers (e.g., 240, 242). In one operating state, the upper left and lower right switches in an H-bridge 236 are turned on while the upper right and lower left switches are turned off, and in another operating state, the upper left and lower right switches in an H-bridge 236 are turned off while the upper right and lower left switches are turned on. Additional windings (e.g., 244, 246) can be provided and connected on the output transformers to balance power through the switching sections 204, 206. There are a number of ways to make the full bridge bidirectional including as discussed above with the antiparallel transistor/diode set with or without an optional capacitor.

Power to the output 248 is provided through secondary windings of the output transformers, with optional capacitors 254 providing voltage doubling to the output or higher multiplication levels (i.e. triplers, quadruplers, etc.).

The switching sections 204, 206 can be in phase with each other or out of phase with each other, for example to cancel or reduce EMI. The switching sections 204, 206 can be stacked in parallel and/or in series to generate single phase output or multi-phase output, stacking them to achieve whatever power handling desired depending on the frequency and size of components. Additional transformers can be included to increase output voltage, and/or voltage doublers or triplers, etc. can be included.

Turning to FIG. 3, in some embodiments the stackable switching modules 300 can be configured with a DC output 310 using rectifiers 302, 304, with optional voltage doubling capacitors 306. Such a DC output 310 can be passed through an inverter if desired and depending on the application to generate a lower frequency AC output suitable for use with appliances designed, for example, for 60 Hz operation. Half bridge rectification, full bridge rectification, other rectification topologies, etc. with for example, but not limited to, diodes and/or synchronous rectifiers using transistors including FETs or bipolar junction transistors (BJTs) as well as insulated gate bipolar transistors (IGBTs) can be used to achieve highly efficient and high voltage AC to DC rectification.

In some embodiments, the stackable switching modules 300 can accept a DC input, such as that from a solar cell power or wind generator, and can convert that to high voltage AC and/or high voltage DC at the output. The power conversion system can thus perform power conversion in either direction, for example to receive power from a power grid for use in local grid-tied storage applications or other applications, or to connect power from, for example, a local power source or other DC input and converting it for connection to a power grid.

N+1 and N+2 or higher redundancy can be built into the modules in case one or two of the output circuits, respectively, should fail, such that the power converters (and inverters) can still operate at full capacity. Some embodiments of the stackable switching modules disclosed herein include an intentionally designed and built-in technique to ensure balancing and to guarantee equal sharing of the voltage/current distribution including in the event of a failure in one or more of the output circuits. The monitor and control system is designed to detect and report failures (alerts) of this type while still continuing to operate at full capacity.

As a non-limiting example application of the stackable switching modules disclosed herein, a 2 kV 4 Amp (8 kW) module can be serially stacked to achieve higher output voltages or stacked in parallel to achieve higher output currents, providing a maximum power output of 8.35 kW for a total of 50 kW for a six pack. Redundant and cooperative active feedback and control to ensure that the high stability of the cathode voltage is not compromised during, for example, pulsed operation (i.e., to mitigate the effects of spurious signals, to reduce droop, etc.) while trying to minimize the stored energy per pulse and the need for large capacitor banks.

In addition to the active control and feedback, including feedforward technology, embodiments of the power conversion system disclosed herein include one or more of the following features in combination: (1) the present invention can operate without any conformal coatings or potting (potting and conformal coatings can be used if desired or for high altitude applications); (2) the present invention is constant voltage and constant current programmable throughout the zero to full scale range by either a digital signal or an analog input which is highly linear between input and output voltage; (3) the present invention is also fully short circuit protected, over voltage, over current and over temperature protected, arc protected (and has both analog and digital arc detection on board); (4) embodiments of the present invention can be air cooled and does not require active/forced air or water cooling.

The power conversion system software/firmware can automatically alert and identify any fault conditions including which individual board or boards are faulty and what the actual fault is. The individual switching modules can be easily field replaced in the event of a fault, and, in some embodiments, are designed to be N+1 and N+2 fault redundant.

In some embodiments, the stackable switching modules support fully isolated (e.g., to 50 kV) digital control and monitoring along with remote operation. These high voltage power supply boards are fully arc and short circuit protected and can operate as a constant voltage or constant current power supply with automatic crossover and zero to full scale operation.

Although some embodiments comprise a voltage-fed DC to DC converter, a current-fed converter is provided in some embodiments by, for example, adding an inductor in series with the ‘+’ leg of the secondary of the transformer, providing a number of beneficial properties including lower EMI, sinusoidal output, eliminate flux imbalance, less chance of transformer saturation, etc. Other topologies including switching converters and inverters such as, but not limited to, buck, buck-boost, boost, boost-buck, push-pull, forward converters, feedforward, Cuk, SEPIC, flyback, current mode, current controlled, sine wave, resonance, etc. can be used.

In some embodiments, the topology is a phase-shifted full bridge for quasi-resonant switching.

One buck-bridge combo powers two transformers and, as shown in FIGS. 2 and 3 have voltage doublers. In some embodiments of the present invention there are a total of at least 4 transformers—two in series for each buck-bridge section. In some embodiments of the present invention there is a three phase bridge feeding these converters. In some embodiments of the present invention there are a number of FETs (210 and 212, respectively) in parallel, and more transformers to handle the power. In some embodiments, the phase shift section would be doubled, as in the two-stage.

Some embodiments of the present invention effectively use quasi-resonant switching for high efficiency and low noise coupled with, for example, a converter stage. To be able to switch rapidly, relatively smaller sized FETs are used with many of these FETs incorporated into a modular design where the FETs are run out of phase for lower ripple. Fast diodes are also used with the doubler topology on the output.

For a 480 VAC input, two module sections of FETs can be used in series. For a 240 VAC input the module sections can be in parallel. Connections could be made on a backplane mother board for this type of input voltage programmability so that the same number of modules is needed at the same input power for either voltage input range. For DC inputs, there is no need for input rectification; however the input voltage can still be converted to a much higher output or intermediary (high) voltage.

In some embodiments for each transformer output, a full bridge of four diodes can be used that feeds a single capacitor. By using a full bridge instead of a doubler the pulsing currents are cut in half, resulting in lower output ripple which, in some embodiments and implementations would only need half as many capacitors but, however would require more diodes.

The windings that are from one transformer to the other are configured to guarantee that the voltage splits/divides at least roughly equally between the transformers as they have series connections on both the input and output sides which can have the two DC outputs after the bridge diodes which are in series.

Multiphase (i.e., 2 or more phases, typically 3 to 4 or 6) interleaved operation is used to minimize ripple, noise and EMI. Using multiphase converter circuits has an advantage of lower device current stress and better efficiency. For example, with a 3 phase bidirectional DC to DC converter where the phase switch is controlled by a respective 120-degree phase shift from each other, the ripple on the total current will be relatively small, thus allowing and only requiring a relatively small amount of capacitance in both the low and high sides while still achieving and realizing acceptable voltage ripple. For example, switch 210 (and 212) and inductor 228 (and 230) and diode 220 (and 222) in FIGS. 2 and 3 can be augmented by two additional sets of switches, inductors and diodes, respectively, resulting in three converters that are phased 120 degrees from each other.

The present invention allows for bidirectional current flow, i.e., current flow from input to output and from output to input depending on, for example, but not limited to, the desired control mode and the relative input and output voltages, energy storage levels, and power needs. As an example to achieve bidirectional operation, the individual switching transistors and diodes in transistors 210 and 212 and diodes 220 and 222, respectively, in FIGS. 2 and 3 can each be replaced with one or more sets of switching transistors in parallel with diodes (especially high speed diodes for use in/with switching power circuits, converters, supplies, etc.) for which the operation of and polarity of current flow can be set by, for example, but not limited to the control interface either manually, automatically or programmed externally. In such a configuration, referred to herein as an antiparallel transistor and diode set, the cathode of an additional diode similar to diode 220 is in parallel with the drain (or collector if the transistor is a BTT or IGBT) of the transistor (e.g., 210), and the anode of the additional diode is in parallel with the source (or emitter) of the transistor (e.g., 210). A similar antiparallel set is formed by adding a transistor to diode 220 in a similar antiparallel connection. An optional capacitor can also be connected across the antiparallel transistor and diode set.

To realize multiphase operation, for example, switch(es) 210 and 212 and inductor(s) 228 and 230 and diode(s) 220 and 222, respectively, in FIGS. 2 and 3 can be augmented by two additional sets of switches and diodes in parallel, inductors and diodes and switches, respectively, in parallel that are phased 120 degrees from each other.

An advantage of some of the embodiments and implementations of the present invention converter topologies includes galvanic isolation between the potential two bidirectional power (i.e., input and output) sources using the relatively compact, small size high frequency transformers, with the use of the same power components for power flow in either direction.

In some embodiments of the present invention, bidirectional dual full-bridges are incorporated into the DC to DC converter including with optional soft switching. As an example, the bridge on one side, which could be the lower voltage side, is current-fed, while the bridge on the other side is voltage fed. Using a voltage clamp branch approach, which, for example, could be composed of an active switch with its anti-paralleled diode and a capacitive energy storage element in series, can be placed across the current-fed bridge to limit transient voltage across the current-fed bridge and realize zero-voltage-switching in, for example, a boost mode operation, while also realizing effectively zero-voltage and zero-current switching for the bridge in the voltage-fed buck mode operation. For buck mode operation, the voltage-fed bridge can, as an example but not limited to, be controlled by phase shift pulse width modulation (PWM).

For example, if isolated bidirectional DC to DC converters are desired and used they can include but are not limited to a current fed isolated bidirectional DC to DC converter with an inductor that behaves like a current source and in many ways similar to a conventional boost converter with an inductor at the input terminals or a voltage fed isolated bidirectional DC to DC converter which has a capacitor at its terminals behaves like a voltage source similar to a conventional buck converter with a capacitor at its input terminals.

Some embodiments of the present invention use half bridge bidirectional converters. An advantage of the half bridge bidirectional converter as compared to the bidirectional Cuk converter is that it only requires one inductor instead of two and that the power switches ratings required for the half bridge bidirectional converter is much lower as compared to the Cuk converter. Cascaded buck boost converters can also be used for non-isolated applications, however the number of devices required by the cascade buck boost converter is twice the number devices in buck-boost bidirectional converter. This can be addressed by using half-bridge Bidirectional DC to DC Converters. Isolated bidirectional DC to DC converters can be used instead of the buck-boost cascade bidirectional converter for applications that require the boost operation only in one direction and the buck in the other.

When the buck and the boost converters are connected in antiparallel arrangement with respect to each other, the resulting circuit is similar to a conventional boost and buck structure with the added feature of being able to handle bidirectional power. A number of different bidirectional approaches can be implemented, including for example, but not limited to cascading the bidirectional buck converter with a bidirectional boost converter. By using this type of bidirectional topology, it allows the output voltage to be either higher or lower than the input voltage depending up on the switch combinations used and the direction of current flow.

Some embodiments of the present invention can incorporate and use maximum power point tracking (MPPT) to optimize/maximize power transfer from photovoltaic (PV) device(s) such as and including solar cells. MPPT techniques, technologies, algorithms, approaches, methodologies, etc. can be incorporated and used with the present invention. In some embodiments of the present invention, MPPT can be incorporated into, for example, each module. In other embodiments and implementations, one MPPT unit may be used for the entire system consisting of a number of modules configured in parallel and series. In some applications and implementations, the output power from the PV solar cells is sufficiently high and also of a magnitude that it would be, for example, more efficient, more practical, most cost effective, provide higher power transfer and better optimize/maximize power transfer, put less stress on parts of the or the whole micro-grid system, etc. and combinations of these, etc. to have more than one MPPT unit (i.e., multiple MPPTs) for a micro-grid system including micro-grid systems that use and incorporate the present invention. Embodiments of the present invention can incorporate both MPPT and PWM based approaches, control and power transfer. Such embodiments can also select in any way or form or mode, etc. including but not limited to, manual, automatic, programmed selection, algorithmic selection, time of day, whether condition, power usage, power source and power consuming types, user preference, override mode, etc., combinations of these, etc. between, for example, but not limited to, MPPT and/versus PWM.

In some embodiments, one or more of the present invention can be implemented to communicate to each other via wireless, wired or powerline communications including locally (i.e., adjacent, nearby, in close proximity) or remotely (located at another place, far apart, etc.) via any of the methods, approaches, ways, interfaces, protocols, etc. discussed herein. Such communications could be autonomous, automatic, relayed through a central control and monitor location or through one or more such locations, set and programmed through a mobile and/or cellular system, web-based, etc.

Implementations of the present invention, including all boards and modules, can be integrated into a single housing with user-easy-to replace plug-in modules and boards.

Operating at higher conversion switching frequencies reduces the size of the magnetics which is favorable to size reduction of the power supply-modulator system.

FIG. 3 illustrates the operation of some embodiments the present invention with an implementation that uses phase-shifted full bridge quasi-resonant switching for high efficiency and low noise. If the input is 480 VAC then the two sections of MOSFET switching shown in FIG. 3 are used in series. As an example, for running on 240 VAC, the two sections of the MOSFET switching shown in FIG. 3 are used in parallel. The choice of 480 VAC or 240 VAC can be automatic (i.e., sensed and set), manual, user selectable—that is there are connections on the module for being able to select either input voltage, etc. and can be used for both DC or AC input voltages ranging from less than 50 volts to greater than 50 kV AC or DC. In some embodiments of the present invention the FETs or other transistors are stacked, for example in series, in such a way to be able to switch, withstand higher breakdown/reverse voltages including up to 50 kV; in other embodiments of the present invention, the modules are stacked so as to be handle, withstand, switch, etc. up to 50 kV at the desired input current/power level using a combination of series and parallel stacked compact-sized high frequency transformer boards and modules.

The implementations can support N+1 and N+2 redundancies which is built into the present invention in case should one or two of the output circuits, respectively, should fail, the present invention could still operate at full capacity. Balancing is used to guarantee equal sharing of the voltage distribution including in the event of a failure in one or more of the output circuits. The monitor and control system is designed to detect and report failures (alerts) of this type while still continuing to operate at full capacity. Embodiments of the present invention can use redundant and cooperative active feedback and control to ensure that the high stability of the voltage (or current) output is not compromised during operation (i.e., to mitigate the effects of spurious signals, droop, overshoot, transients, etc.) while, for example, trying to minimize the stored energy.

The present invention can use, for example, but not limited to, boost, push-pull and forward converter, half- and full-bridge, flyback for both current-mode and current-fed, etc. combinations of these, topologies, etc.

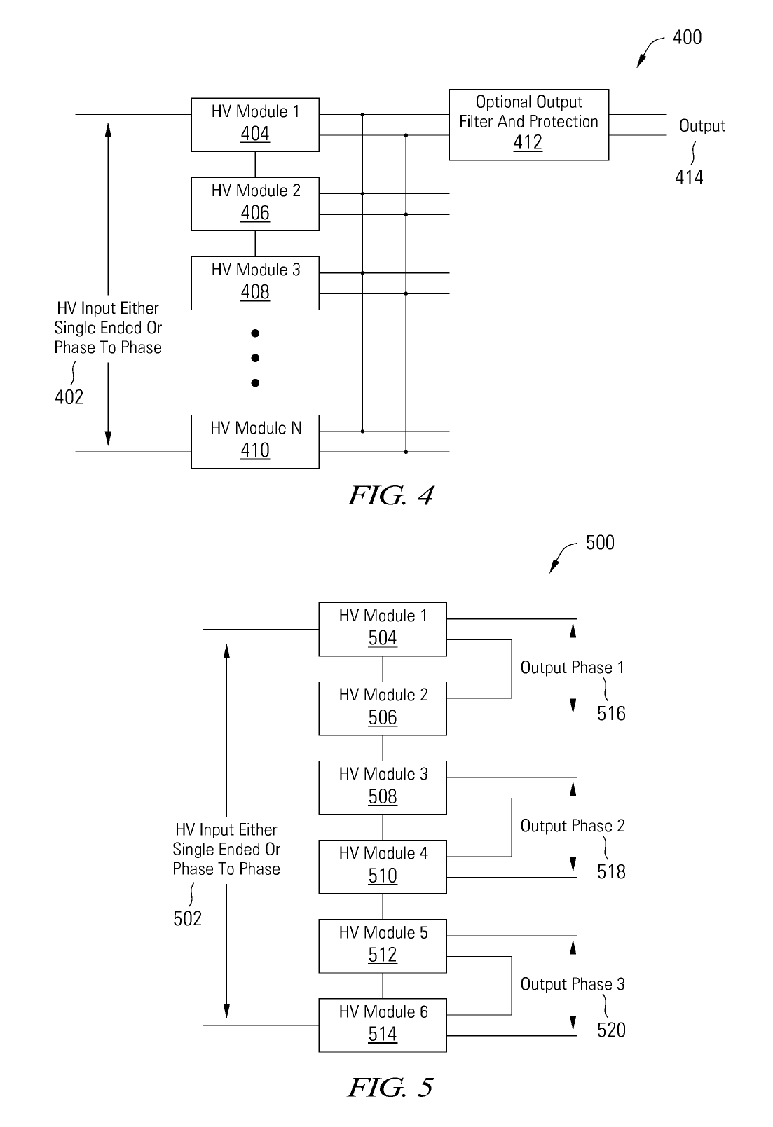

Turning to FIG. 4, a block diagram of a power conversion system 400 is depicted in accordance with some embodiments of the invention, including any number of stackable switching modules (e.g., 404, 406, 408, 410). The modules can be ganged/stacked/configured in series or parallel or both. A high voltage (HV) input 402 can be either HV direct current (DC) or rectified and optionally power factor corrected DC from an alternating current (AC) source. The modules (e.g., 404, 406, 408, 410) can contain all of the electronics and circuits necessary to convert the high voltage to low(er) voltage DC or invert to low(er) voltage, low frequency (i.e., 50, 60, or 400, etc. Hz) AC voltage and power at output 414. The optional filter and protection 412 (both input and output) can be incorporated into each module (e.g., 404, 406, 408, 410) as a stand-alone function or use one or more external to the module units, etc., or combinations of both, etc.

As an example if the HV DC input is 15 kV and each module can support 5 kV, then a minimum of 3 modules stacked/configured in series are needed. As another example if the HV DC input is 35 kV and each module can support 10 kV, then a minimum of 4 modules stacked/configured in series are needed. As yet another example if the HV DC input is 50 kV and each module can support 12 kV, then a minimum of 5 modules stacked/configured in series are needed which could support up to 60 kV input.

The power conversion system 400 can, for example, but not limited to, use phase to phase as the input in a multiphase (i.e., 3 phase) grid system or single phase system use the phase to ground.

Turning to FIG. 5, some embodiments of a power conversion system 500 can use any number of stackable switching modules (e.g., 504, 506, 508, 510, 512, 514), ganged/stacked/configured at least partially in parallel, converting a high voltage (HV) input 502 of either HV direct current (DC) or rectified and optionally power factor corrected DC from an alternating current (AC) source to yield multiphase outputs 516, 518, 520. Again, the modules (e.g., 504, 506, 508, 510, 512, 514) can contain all of the electronics and circuits necessary to convert the high voltage to low(er) voltage DC or invert to low(er) voltage, low frequency (i.e., 50, 60, or 400, etc. Hz) AC voltage and power at outputs 516, 518, 520 in any configuration, number and angle of output phases, etc.

The present invention also includes micro or mini modules that can be used on the grid or mini or micro grids which are self-contained modules that can be configured in parallel or series or combinations to be able to support AC or DC grid voltages up to 50 kV or higher and can also be bidirectional. Embodiments of the present micro or mini modules invention for receiving high voltage grid power may not need to have output capacitors or, depending on the modules, output bridges and, instead use inverters to directly take the high frequency AC output of the relatively small, compact high frequency transformers and provide frequency conversion (typically from tens of kHz up to greater than 1 MHz down to low frequencies such as 50 Hz, 60 Hz or 400 Hz) and voltage down-conversion from typically kV to tens to hundreds of kV down to 120 VAC, 240 VAC, 277 VAC, 347 VAC, 480 VAC, etc.

The diodes used for the present invention can be made of any appropriate material or materials and have an appropriate voltage rating including reverse voltage rating and, for example, but not limited to recovery time, including reverse recovery time. For example, SiC and/or GaN-based diodes may be used including but not limited to SiC and GaN-based Schottky diodes which, for example, could each have a reverse voltage breakdown rating of 1000s of volts and essentially no recovery time allowing very high speed, high frequency switching which could further reduce the size of the small, compact transformers. Should the voltage or current be higher than the ratings for the individual diodes, the diodes can be stacked and configured in series, parallel, etc., combinations of these, etc. to achieve the desired voltage and or current rating safely and conservatively.

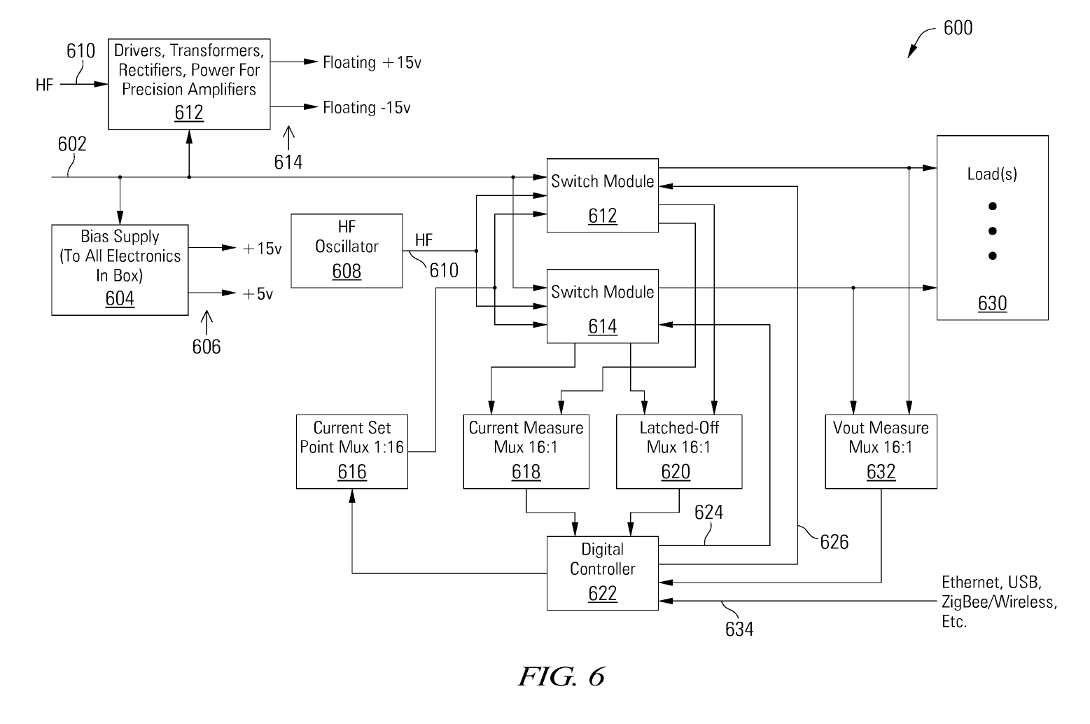

Turning to FIG. 6, a power conversion system 600 with digital controller 622 is depicted in accordance with some embodiments of the invention. Multiple switch modules (e.g., 612, 614) can be stacked to provide the desired power capacity to the load 630. A high voltage DC input 602 is provided to the switch modules (e.g., 612, 614). In other embodiments, as discussed above, an AC input can be supported using rectifiers or other suitable circuits. Switching in the switch modules (e.g., 612, 614) is controlled by a high frequency oscillator 608 which generates a high frequency control signal 610, in some embodiments comprising a 100 kHz sinusoid. Note that although 100 kHz is mentioned here, the frequency could be higher or lower, preferably higher and into the MHz range or higher. The high frequency control signal 610 can also be provided to drivers, transformers, rectifiers, precision amplifiers 612, which provide power 614 for internal circuits and components in the power conversion system 600, for example, but not limited to, providing floating +15 (or, for example, 25 V) and −15 V (or, for example, −25 V) power based on the HV DC input 602. Other power signals 606 can be generated as needed based on the HV DC input 602 by any suitable bias supply circuit 604 and can be further powered by a tag along inductor.

The digital controller 622 can be configured to perform any number of control functions in the power conversion system 600, for example controlling the current set point for the switch modules (e.g., 612, 614) via a current set point multiplexer 616 supporting 16 switch modules (e.g., 612, 614). A current measurement multiplexer 618 provides current feedback from the switch modules (e.g., 612, 614) to the digital controller 622. Individual enable signals (e.g., 624, 626) from the digital controller 622 can enable and disable the switch modules (e.g., 612, 614), and a latched-off multiplexer 620 can provide feedback about the operating state of the switch modules (e.g., 612, 614) to the digital controller 622. An output voltage measurement multiplexer 632 can measure the output voltage (and/or other characteristics about the output) for the digital controller 622. A wired (e.g., Ethernet, USB, etc.) and/or wireless (e.g., ZigBee, IEEE 802, WiFi, Bluetooth, Bluetooth Low Energy, Zwave, cellular communications, RF, microwave, optical, etc.) monitoring and control interface 634 can provide and implement a command set for remote control and monitoring including providing for status and alarms and over-ride commands.

Note that several components are shared, including the 100 kHz oscillator 608, the bias supply 604 among the current set point Mux 616, current measurement Mux 618, the latched off Mux 620, the output voltage Mux 632, and the digital controller/remote interface, between the 16 module channels.

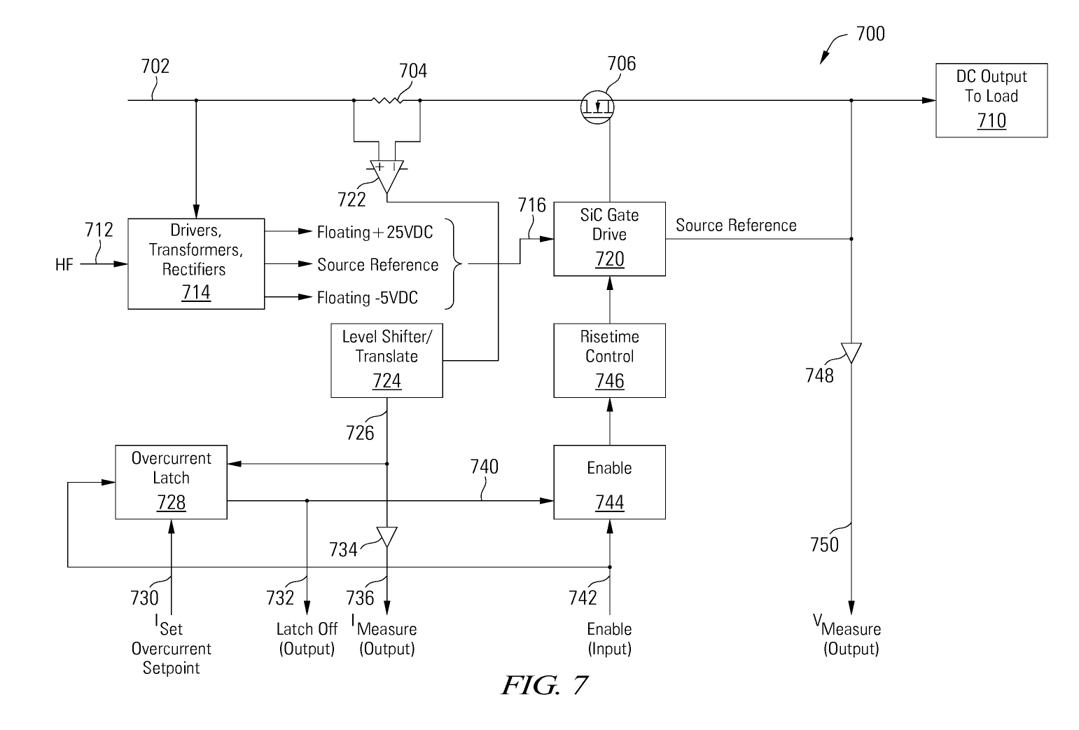

Turning now to FIG. 7, a block diagram of an example solid state circuit protection (SSCP) circuit 700 for a power conversion system is depicted in accordance with some embodiments of the invention. In some embodiments, the SSCP circuit 700 comprises a 600 VDC SiC SSCP and Distribution Module, a gangable/stackable switching module that can be stacked in an array of N modules. A switch 706 such as, but not limited to, a SiC FET or multiple SiC FETs connected in parallel to achieve the desired R_{dson} (e.g., 10 mΩ) for the switch module, controls current from the high voltage DC input 702 to a DC output 710. A gate drive circuit 720 controls the switch 706. A high frequency signal 712 such as, but not limited to, a 100 kHz sinusoid as discussed above, is provided as needed to drivers, transformers, rectifiers 714 etc. to generate gate drive voltages 716 for the gate drive circuit 720. In some embodiments using a SiC FET or parallel SiC FETs as the switch 706, the gate drive voltages 716 can include +25 V and −5 V bus voltages. The +25 is designed to be flexible and adjustable to an on-state gate drive of 20 V. Likewise, the lower bus voltage of −5 V can be adjusted down to, for example −2 V, 0 or even a positive voltage. An enable input 742 is provided in some embodiments to an enable circuit 744 which can enable/disable the gate drive 720, via an optional risetime control circuit 746.

Output current is measured in some embodiments using a low impedance sense resistor 704 and a precision amplifier 722, the output of which can be translated by a level shifter 724 to yield a current feedback signal 726. The current feedback signal 726 can be buffered 734 as needed to provide a current measurement output 736. An overcurrent latch 728 can receive the current feedback signal 726 and can also receive the enable input 742, in order to disable the system at least temporarily in the event of overcurrent conditions, based on an overcurrent setpoint 730. A latch-off output 732 provides an indication of when the system is disabled due to overcurrent conditions. The output voltage to the load can also be buffered 748 anad provided as an output voltage measurement 750.

In summary, for each of the SSCP modules (e.g., 700) included in a power conversion system, some embodiments use N-Channel FETs; use one or more low or sub-milliohm four terminal sense resistor as the current sense and for feedback, a precision op amp for current sense amplifier, a level-shifter to translate the current measure signal to ground reference, for both the module latch-off current limit, and for the reporting to the digital controller, a resettable latch-off current limit that sets when the measured current exceeds the current set by the digital controller where, for example, cycling Enable resets this latch; an Enable circuit, that receives an Enable signal from the digital controller, and, for example, ANDs it with the current limit-latch off; A rise time control, set for approximately 1 millisecond (or shorter or longer) that is also programmable; a gate drive, which translates the FET drive up to the Source Reference, and also buffers the signal; a signal out to indicate over current latch; a buffer and scaler for the measured output voltage; a floating drive generator for the gate drive which is +25V and −5V referenced to the respective channel output of the N modules.

For many embodiments, each of the channels for the present invention can be independently and individually protected by fast response, fast acting analog fault protection including over-current, arc, ground fault, ground isolation fault, short circuit, over-voltage and under-voltage protection in addition to redundant and overlapping high speed digital fault protection and reporting. Embodiments of the present invention allow the system software/firmware to automatically alert and identify any fault conditions including which individual board(s) is/are faulty and what the actual fault is. The individual boards and modules can be easily field replaced in the event of a fault. Again, even under a fault condition, embodiments of the present invention are N+1 and N+2 fault redundant.

The present invention allows the modules to be gangable/stackable and provide, for example, equal sharing of the voltage and current distribution including in the event of a failure in one or more of the output circuits.

The monitor and control system is designed to detect and report failures (alerts) of this type while still continuing to operate at, or in the worst case, near full capacity.

The control, monitoring, analytics and integration provide robust stable operation that can have both analog and digital programmable over-current protection, advanced risetime control, fast response, full temperature monitoring and control, including over-temperature shut-down and override, have micro-controller and digital signal processing (DSP) microprocessor monitor, control, fault detection and response, self-diagnostics, fault detection and protection, intelligent local and remote monitoring and control while delivering high-kilowatt output power and are fully protected including protected against arcs, shorts, over voltage, over current and over temperature and remote interfacing.

The monitor and control system can detect and report failures (alerts) of this type while still continuing to operate at, or in the worst case, near full capacity.

Implementations of the present invention provide for easy field replacement in the event of a fault. Even under a fault condition, the present invention can be designed to be N+1 and N+2 fault redundant.

In some embodiments and implementations of the present invention, the modules are hot swappable.

Mechanical circuit breakers may also be used in addition to the built-in electrical circuit breakers as well as being part of the over-voltage, over-current, over-temperature monitors and control and other thermal protection and circuit protection and can be linked and included as part of the extensive and advanced wired and optional wireless monitoring and data logging of the power supply and modulator including thermal monitoring, control and management.

In some embodiments, the monitoring, interface and control strategies are configured to prevent or mitigate any known fault scenarios, and can include set points and over-current/over pressure monitoring and alarms.

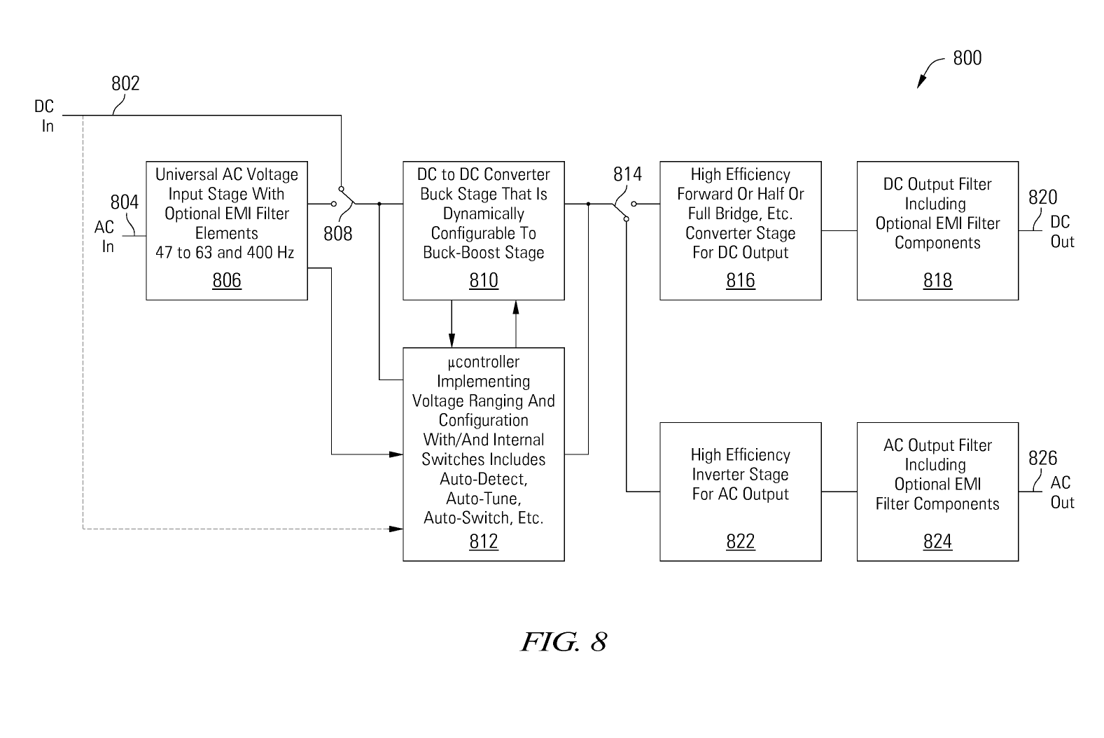

Turning to FIG. 8, a block diagram of a power conversion system 800 with selectable AC/DC in, AC/DC out is depicted in accordance with some embodiments of the invention. Either a DC input 802 or an AC input 804 rectified by a universal AC voltage input stage 806 can be switchably connected to a DC to DC converter 810 by any suitable switch 808 or switches, and can be controlled/programmed in any suitable manner, including by automatically detecting the input type and values. The DC to DC converter 810 can be a buck stage that is dynamically configurable to a buck-boost stage, or can be a boost, boost-buck, flyback, forward converter, Cuk, SEPIC or any other type of converter. The DC input 802 can have any voltage level, including high voltages. The AC input 804 can have any voltage level, frequency, and number of phases. As a non-limiting example, the AC input 804 may have a frequency of 50 Hz, 60 Hz, or even up to several hundred Hz, may be single-phase, two-phase, three-phase. A controller 812 such as, but not limited to, a micro-controller based circuit can be used to implement voltage ranging and configuration, auto-detect, auto-tune, auto-switch etc. using internal switches.

The power conversion system 800 can also provide a DC output 820 and/or AC output 826, for example by switching the DC to DC converter output using one or more switches 814 of any type including but not limited to bidirectional switches of any type or form. The DC output 820 can be generated, for example, using a high efficiency forward or half or full bridge, etc., converter stage 816 and DC output filter 818 including EMI filter components if desired. The AC output 826 can be generated, for example, using a high efficiency inverter stage 822 and AC output filter 824 including EMI filter components if desired.

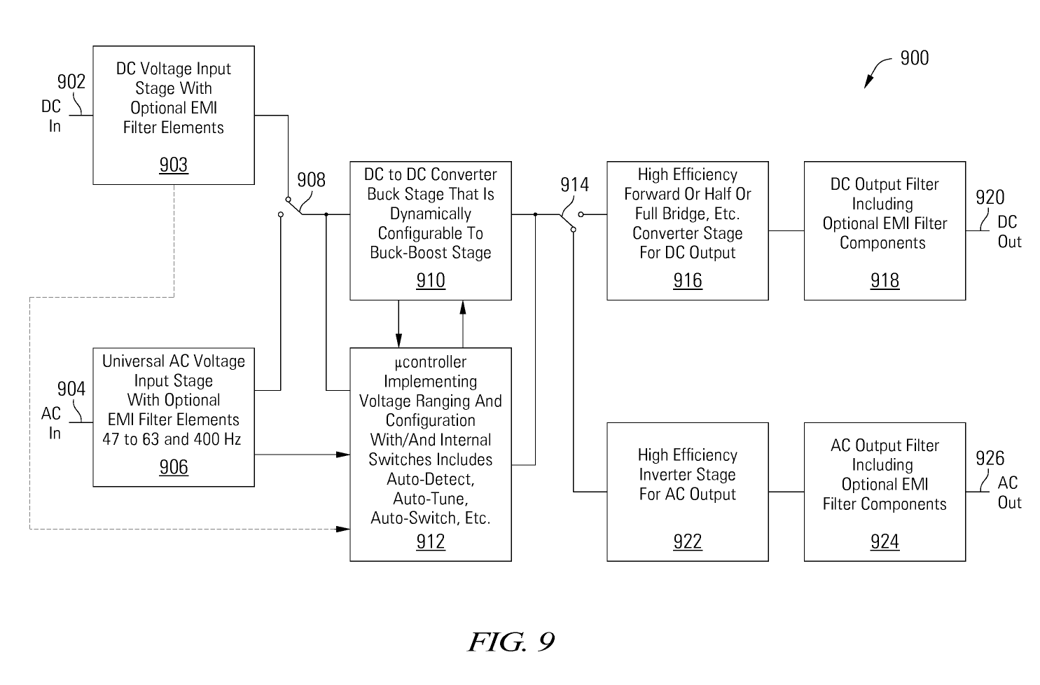

Turning to FIG. 9, some embodiments can include a DC voltage input stage with optional EMI filter components. Either a DC input 902 via a DC voltage input stage 903 or an AC input 904 rectified by a universal AC voltage input stage 906 can be switchably connected to a DC to DC converter 910 by any suitable switch 908 or switches including but not limited to bidirectional switches of any type or form, and can be controlled/programmed in any suitable manner, including by automatically detecting the input type and values. The DC to DC converter 910 can be a buck stage that is dynamically configurable to a buck-boost stage, or can be a boost, boost-buck, flyback, forward converter, Cuk, SEPIC or any other type of converter. The DC input 902 can have any voltage level, including high voltages. The AC input 904 can have any voltage level, frequency, and number of phases. As a non-limiting example, the AC input 904 may have a frequency of 50 Hz, 60 Hz, or even up to several hundred Hz, may be single-phase, two-phase, three-phase. A controller 912 such as, but not limited to, a micro-controller based circuit can be used to implement voltage ranging and configuration, auto-detect, auto-tune, auto-switch etc. using internal switches.

The power conversion system 900 can also provide a DC output 920 and/or AC output 926, for example by switching the DC to DC converter output using one or more switches 914 of any type. The DC output 920 can be generated, for example, using a high efficiency forward or half or full bridge, etc., converter stage 916 and DC output filter 918 including EMI filter components if desired. The AC output 926 can be generated, for example, using a high efficiency inverter stage 922 and AC output filter 924 including EMI filter components if desired.

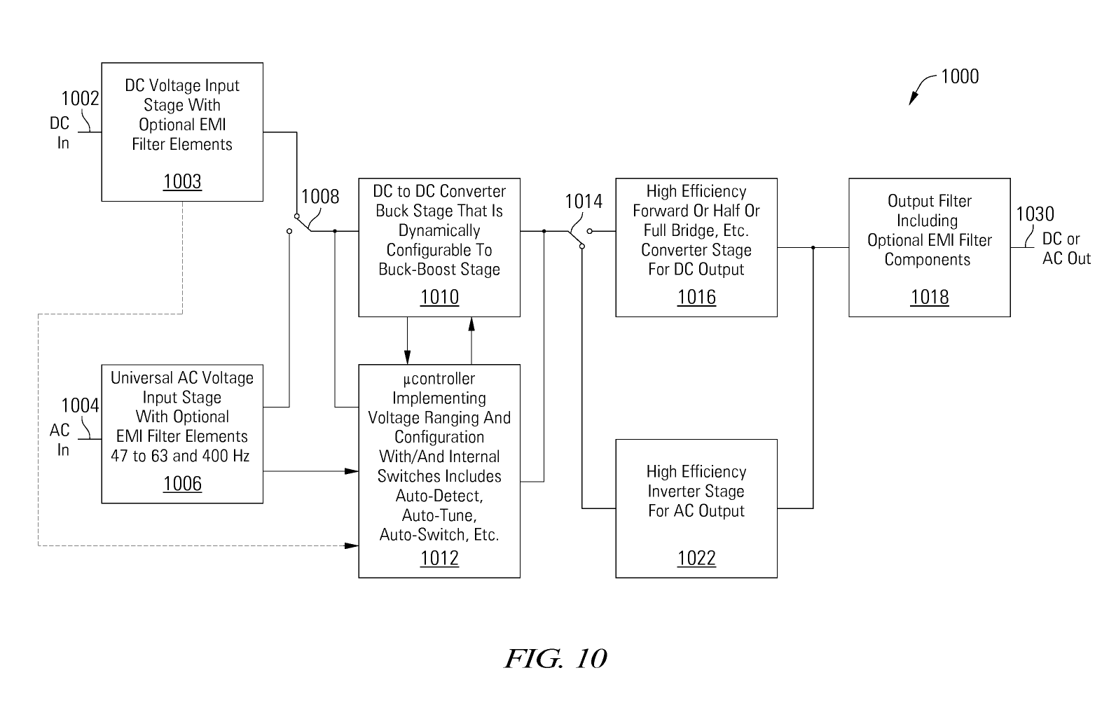

Turning to FIG. 10, some embodiments provide either a DC or an AC output 1030. Either a DC input 1002 via a DC voltage input stage 1003 or an AC input 1004 rectified by a universal AC voltage input stage 1006 can be switchably connected to a DC to DC converter 1010 by any suitable switch 1008 or switches including but not limited to bidirectional switches of any type or form, and can be controlled/programmed in any suitable manner, including by automatically detecting the input type and values. The DC to DC converter 1010 can be a buck stage that is dynamically configurable to a buck-boost stage, or can be a boost, boost-buck, flyback, forward converter, Cuk, SEPIC or any other type of converter. The DC input 1002 can have any voltage level, including high voltages. The AC input 1004 can have any voltage level, frequency, and number of phases. As a non-limiting example, the AC input 1004 may have a frequency of 50 Hz, 60 Hz, or even up to several hundred Hz, may be single-phase, two-phase, three-phase. A controller 1012 such as, but not limited to, a micro-controller based circuit can be used to implement voltage ranging and configuration, auto-detect, auto-tune, auto-switch etc. using internal switches.

The power conversion system 1000 can also provide a DC output 1020 and/or AC output 1026, for example by switching the DC to DC converter output using one or more switches 1014 of any type. The DC output 1020 can be generated, for example, using a high efficiency forward or half or full bridge, etc., converter stage 1016 and DC output filter 1018 including EMI filter components if desired or needed. The AC output 1026 can be generated, for example, using a high efficiency inverter stage 1022 and AC output filter 1024 including EMI filter components if desired.

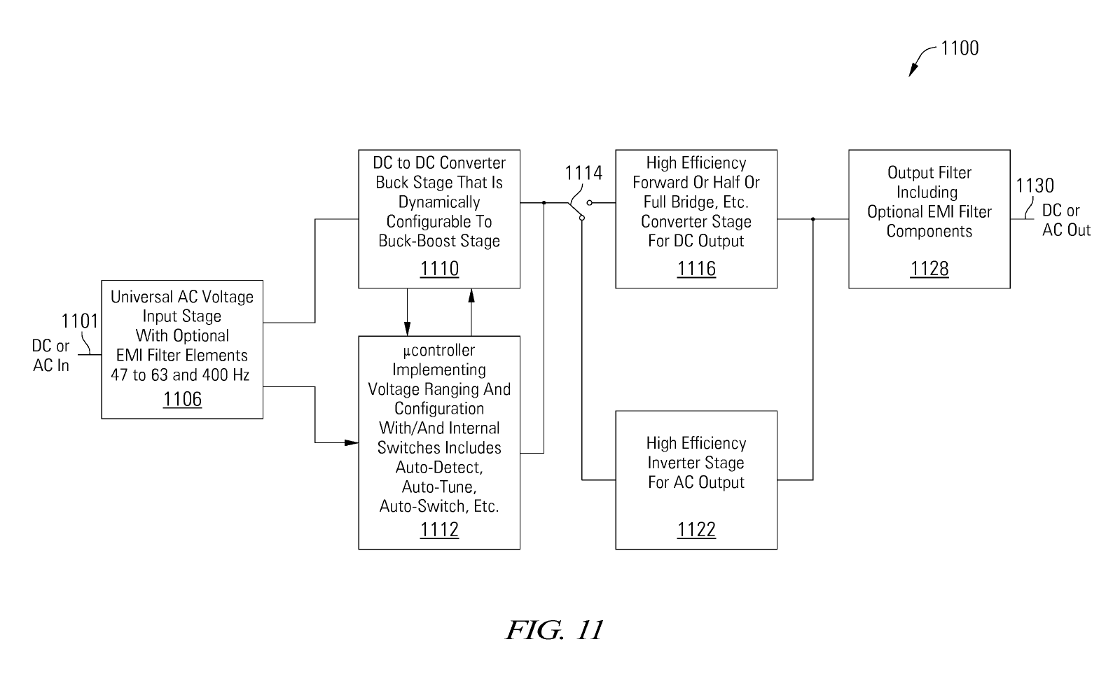

Turning to FIG. 11, in some embodiments either a DC or AC input 1101 can be processed by a universal AC voltage input stage 1106, with the output of the universal AC voltage input stage 1106 comprising a DC voltage provided to a DC to DC converter 1110. The DC to DC converter 1110 can be a buck stage that is dynamically configurable to a buck-boost stage, or can be a boost, boost-buck, flyback, forward converter, Cuk, SEPIC or any other type of converter. The input 1101 can be a DC signal of any voltage level, including high voltages, or an AC signal having any voltage level, frequency, and number of phases. As a non-limiting example, the input 1101 may be an AC signal having a frequency of 50 Hz, 60 Hz, or even up to several hundred Hz, may be single-phase, two-phase, three-phase. A controller 1112 such as, but not limited to, a micro-controller based circuit can be used to implement voltage ranging and configuration, auto-detect, auto-tune, auto-switch etc. using internal switches including but not limited to bidirectional switches of any type or form.

The power conversion system 1100 can also provide a DC or AC output 1130, for example by switching the DC to DC converter output using one or more switches 1114 of any type including but not limited to bidirectional switches of any type or form. The DC output 1120 can be generated, for example, using a high efficiency forward or half or full bridge, etc., converter stage 1116 and output filter 1128 including EMI filter components if desired. The AC output 1126 can be generated, for example, using a high efficiency inverter stage 1122 and the output filter 1128 including EMI filter components if desired.

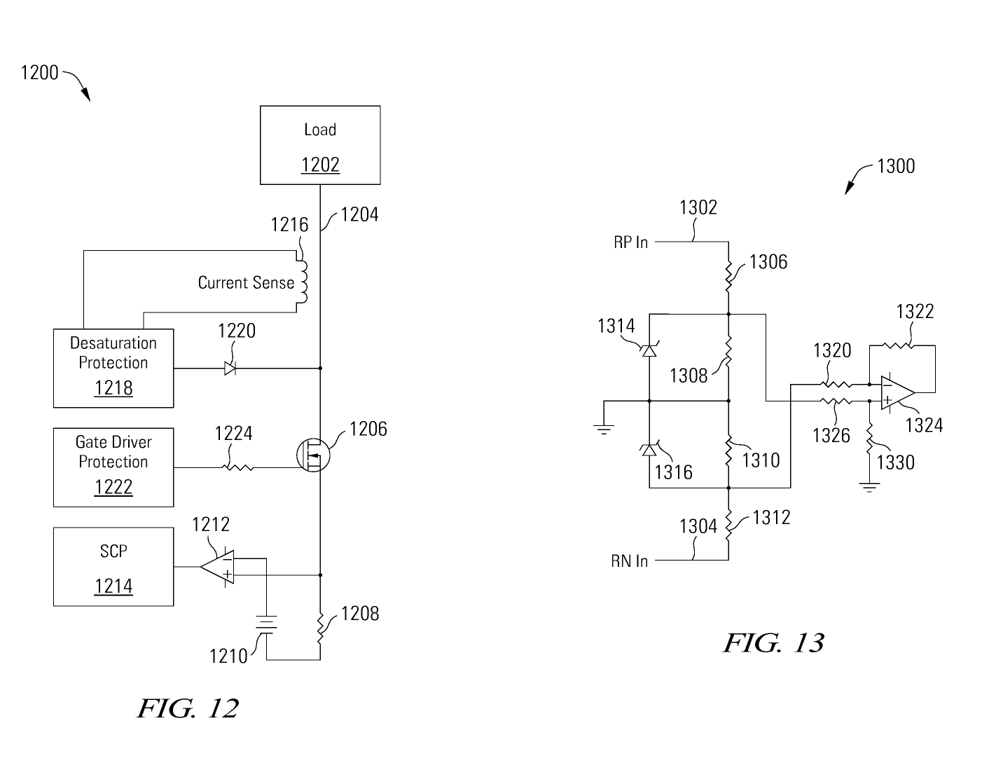

Turning to FIG. 12, a block diagram of an over current/short circuit protection detector 1200 is depicted in accordance with some embodiments of the invention. Current to the load 1202 is switched by one or more FETs 1206 including but not limited to bidirectional switches of any type or form, which may or may not directly be part of the switching action or network on the DC to DC converter or the other converters and/or inverters as discussed above, which could also be controlled by a gate driver protection circuit 1222 via an R_{gate} resistor 1224. A desaturation protection circuit 1218 is connected to the drain of the N-channel FET 1206 through diode 1220 to protect against desaturation, based at least in part on the load current inductively sensed by inductor 1216 or in any other manner. A solid state circuit protection module 1214 is controlled, for example but not limited to, based on a comparison by an error amplifier 1212 between the current set point voltage across a sense resistor 108 and a voltage reference 1210.

Note that a number of components are not shown in FIG. 12 including an oscillator (e.g., a 100 kHz oscillator) and associated isolation transformer, the isolated and floating bias supply. Note, that although 100 kHz is mentioned here, the frequency could be higher or lower, preferably higher and into the MHz range or higher. The current set point, although represented by a battery 1210 in FIG. 12, can be any type of reference including but not limited to a programmable precise and stable reference voltage. The current measurement is made using, for example, one or more of a precision current sense resistor 1208, a precision current transformer and/or Hall Effect sensor or, in some cases, one or more precision current resistors, combinations of these and other types sensing elements. The circuit shown in FIG. 13 illustrates one of the protection detection circuits that can detect an asymmetrical imbalance in the +VDC and −VDC (should implementation of the present invention support both polarities—i.e., be bipolar) supplies with respect to ground (chassis). The voltage across inputs 1302, 1304 is sensed by amplifier 1324, with resistors 1320, 1322, 1326, 1330 configuring the amplifier 1324 as desired. Resistors 1306, 1308, 1310, 1312 are connected between inputs 1302, 1304, with Zener diodes 1314, 1316 connected between ground and the outputs of the resistor network 1320, 1322, 1326, 1330 as shown to limit the voltage.

Additional more sophisticated circuits can separately detect imbalances in the +VDC and −VDC respective currents and also ground current with respect to each (i.e., +/−) VDC power supplies. The isolation to ground from either the +VDC or the −VDC supply rails can be constantly monitored by several methods including circuits that essentially act as an effective resistance (or “megger”) meter that can detect even minute ground fault currents and ground isolation failures and faults. Arc detection including flash arc detection can be implemented, for example and not limited to, monitoring the signals and signs of arcing using fast current sense monitors and voltage monitors. These arc detection circuits, techniques and approaches can be modified to set the level and provide arc detection, protection and correction for the present invention. This arc detect and protect consists of both an ultra-fast analog and very fast digital arc detection and protection suite. Both the analog and digital arc detection and protection can be fully programmable and adjustable and can include single and multiple arc detects before trip, fault clear condition(s) before reset, automatic reset, hiccup mode, etc. These can be used to determine fault conditions including ground isolation fault (GIF), single and double (catastrophic) GIF, under-voltage, over-voltage, over-current, over-temperature, reverse voltage, direct shorts, dI/dt faults, dV/dt faults, interlinks and interlocks detection, monitoring and faults. In addition, complete and detailed diagnostics for all of the above faults can be provided and communicated by Ethernet, Wireless including but not limited to WiFi, Bluetooth, ZigBee, Zwave, ISM, etc., wired including CAN J1939, UARTs, serial, parallel interfaces, I2C, SPI, RS232, etc., powerline, other communications interfaces, protocols, etc., discussed herein, all or a subset of these, etc. Such communications could include, for example, but not limited to:

1. Communicate using one or more of wired, wireless, powerline for diagnostics, programming, on/off control

2. Have ground fault detection

3. Have Arc Flash Protection

4. Cable interlink protection in which a mechanically based electrical signal will indicate true established connection of the cable to the output device/load. Cable interlink protection shall prevent high voltage power from being applied to an output unless an interlock has been established, verifying that a cable is connected. This applies to high voltage cables and is intended to protect personnel from inadvertent contact with high voltage.

5. Ability to “soft start” high voltage loads by limiting current inrush upon closing the circuit—this can, for example, but not limited to, be accomplished by a PWM/duty cycle ramp signal to the gate of FETs for purely capacitive and resistive loads and AC/DC and/or DC/DC converters and DC/AC inverters and a modified version for inductively detected loads. The fault detection circuits will “probe” for shorts and GIFs as part of the ‘soft start” after all interlocks and interlinks have been interrogated and found to be valid. The high voltage electrical cables could also include high voltage interlocks from the output connector of the power source through to the input connector of the load and high voltage interlock circuits and passive circuits shall be used in the utilization equipment which could also be used to detect unlocked condition. Under such unlocked conditions, the interlock will prevent activation of the high voltage power transfer and, in some situations could also deactivate the power line if it is already active.

6. Circuits could be default off when initially powered up. For enhancement FETs (i.e., MOSFETs), this is a relatively straightforward task and requirement as a voltage to the gate is needed to turn on enhancement FETs. For depletion FETs (i.e., JFETs and some MOSFETs), being in the turned-off mode requires a reverse bias voltage needs to be applied.

A. Using a low voltage bias buss, for example, 28 volts DC to control the electronics and circuits to provide power which will be used with, for example, isolated power supplies to power the gate, solid state circuit protection (SSCP) which can electrically perform as a circuit breaker and distribution circuits and systems to provide a negative polarity to the gate upon initial power up to result in a default output power off.

B. In the unlikely event of a failure of the 15 (or 25 V or 28 V, etc.) DC control power, power the isolated power supplies to power the gate, SSCP and distribution circuits and systems using the +/−V rails so that a negative bias can be assured to be applied to the respective FETs (if SiC or depletion mode N-Channel FETs are used) comprising the + and −VDC of the SSCP and distribution units so as turn off the output to for each rail.

C. Use a scaled down and Zener protected voltage of the opposing rail to initially reverse bias the depletion mode SiC FETs (since the SiC FETs are NFETs).

Embodiments and implementations of the present invention can detect voltage and current on each output including reverse polarity connections and ensure that a fault condition is triggered without damage to the SSCP, distribution units, wiring, connections or load. This can be accomplished, for example, by using voltage and current sense circuits. Detect temperature of internal electronics which, for example can be accomplished by providing thermocouple measurements at appropriate locations in the present invention as well as the SSCP and power grid distribution unit. Bipolar/CMOS/DMOS and/or SOI integrated circuits can be used with both internal temperature and external input temperature measurement capabilities. The over-temperature warning and trip conditions shall be programmable via the one or more wired, wireless, powerline interface(s).

The internal transformer stages can be ganged and connected in series and/or parallel and/or combinations of these and can be manually or automatically configured to accept either a DC or an AC input and can also measure/sample the input and configure the transformer stages to support and be able to withstand and accept the input voltage level. In a similar fashion the outputs can be ganged in any manner to achieve desired level of voltage and current delivery with associated circuit protection. The outputs can have the ability via the wired, wireless, powerline interfaces to be programmed to trip below their maximum capability.

Embodiments of the present invention can ensure active discharge of power lines in the event of an unlocked interlock. The power distribution will have a pre-charge circuit for safe initial activation for all high voltage power feeds. Pre-charge can, for example, but not limited to, be initiated when the power feed is switched on and shall ramp up the voltage no faster at an appropriate rate and the pre-charge circuit which could transition to full activation at, as a non-limiting example only, 565 V (current limiting function is no longer needed). If the power line does not achieve 565 volts within 30 seconds, the pre-charge circuit could deactivate the power line.

The present invention can also provide blocking of the Bi-directional power transfer. Overcurrent Fault and Normally-on Devices Overcurrent faults in converters can also occur including with a shoot-through fault. Using wide bandgap devices SiC or GaN devices typically allows for higher junction temperature, faster switching speeds and low switching losses especially compared to Si devices. Such wide bandgap devices can be used and incorporated into converters including current fed, etc. as well as synchronous and current-fed active rectifiers, etc. and can also be used in voltage and/or current source inverters

For normally-on (depletion) devices, when there is no voltage applied between the gate and source the FET is turned-on. This to turn off the device the gate drive must be driven negative with respect to the source. This can increase the risk of shoot-through faults, including shorting of the dc link, in voltage-fed phase converters especially if this results in shorting across the lines of the power source. Therefore in some applications redundancy is used for the FETs as well as a separate normally-off (enhancement mode) as well as back up electromechanical devices including relays and circuit breakers.

To mitigate or eliminate any AC or DC link short-circuit faults, short-circuit protection circuits that use a sense resistor or resistors or current sense transformers, combinations of these, etc. are used to monitor for high current events. In addition, gate current monitoring circuit monitors the gate current of the power switch for potential gate condition issues including normal operation, abnormal (i.e., slow gate charging/discharging) and shorted gate where a high dc gate current is detected. In addition, desaturation monitoring circuits can be used to measure the collector to emitter (VCE) or drain to source (VDS) across the power switch. If, for example, the turned-on state voltage exceeds a programmable or set value such that the device is not operating in saturation, a fault signal is generated and appropriate action can be taken. Example fault modes include: overcurrent or short circuit both typically result in much higher than anticipated currents. The operation frequency can be >100 kHz and, depending on the specifics of the wide bandgap devices, wide operating temperature range of potentially typically −55° C. to 200° C., with on-chip voltage regulator(s), cross conduction protection with temperature independent dead time, under-voltage lockout (UVLO) protection, short-circuit/overcurrent) protection, gate current monitoring, desaturation protection, very low power thermal shutdown protection, and one or more charge pumps to allow up to 100% duty cycle operation for PWM or MPPT modes if so needed.

Each of the Switching Modules for the present invention has, for example, but not limited to, a power input, and a power output. As an example, each of these Switching Modules can, for example, have two signal inputs: A digital Enable input signal and an analog current level set input. Each of the Switching Modules can, for example, have three signal outputs: a digital signal to indicate if the channel is latched off from over-current; a buffered and scaled analog current measurement of that channel and a buffered and scaled analog voltage measurement of that channel output.

As an example embodiment, the digital controller section could contain: One or more bi-directional interfaces; N discrete enables, one for each Switching module; N analog current set points; N digital current latch-off signals that are scanned and read; 2N analog signals: N current and N voltage that are scanned and read, +25, +15V and +5V, −5V etc. bias supply to run the electronics; a master (100 kHz) oscillator for the floating bias supplies; input and output connectors; and a floating bias supply generator for the precision op amps, powered by the 28 VDC input.

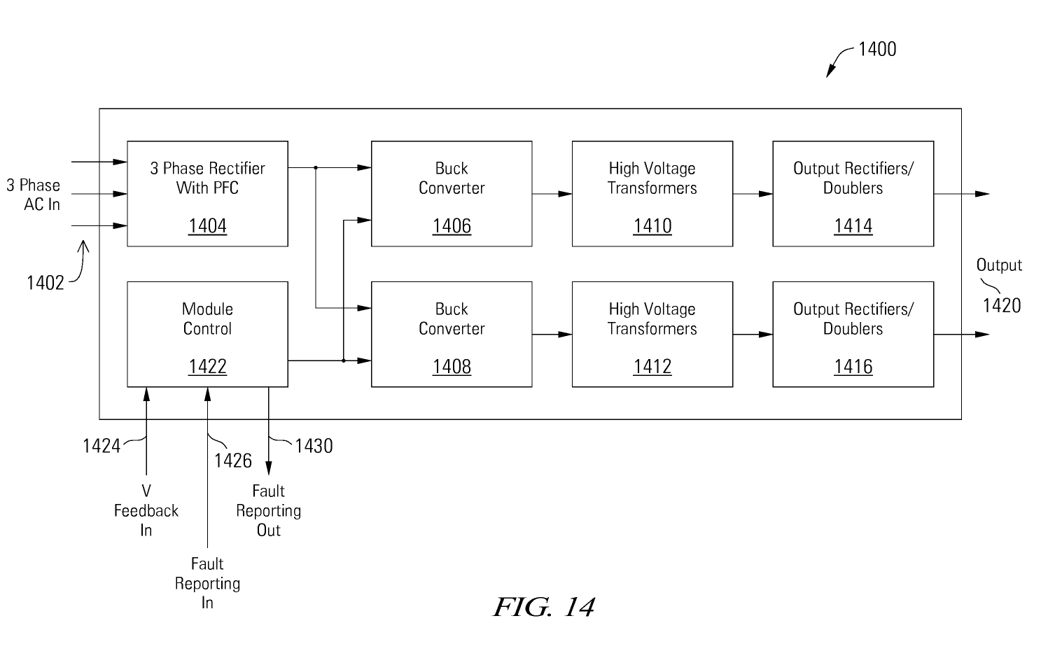

Turning to FIG. 14, a block diagram of a stackable high voltage module 1400 is depicted in accordance with some embodiments of the invention. In this example embodiment, a 3 phase AC input 1402 is converted to a high voltage DC output 1420, although as discussed above, conversion can be performed in either direction, with AC or DC inputs and outputs. In this example, a 3 phase rectifier with power factor correction 1404 rectifies the AC input 1402 and provides the rectified power to stackable buck converters 1406, 1408 or other (e.g., buck-boost, boost, boost-buck, flyback, forward converter, Cuk, SEPIC, etc,) converters. The converters 1406, 1408 feed high voltage transformers 1410, 1412 which are switched as discussed above. The outputs are provided to output rectifiers/doublers 1414, 1416, yielding a high power, high voltage DC output 1420. A control circuit 1422 for the stackable module 1400 controls the converters 1406, 1408 and/or high voltage transformers 1410, 1412, and can be based on voltage feedback 1424 and/or other status indicators as disclosed above, can provide fault reporting output 1430, can receive fault reporting input 1426. Such fault handling can include, but is not limited to, ground isolation faults (GIF), single and double (catastrophic) GIF, under-voltage, over-voltage, over-current, over-temperature, reverse voltage, direct shorts, dI/dt faults, dV/dt faults, interlinks and interlocks detection, etc.

In addition to the active control and feedback, including feedforward technology, the present invention can operate without any conformal coatings or potting; (2) implementations of the present invention can be constant voltage and constant current programmable throughout the zero to full scale range by either a digital signal or, as shown in FIG. 14 for the output voltage, an analog input voltage referenced, for example, to earth ground; short circuit protected, over voltage, over current and over temperature protected, arc protected (and has both analog and digital arc detection).

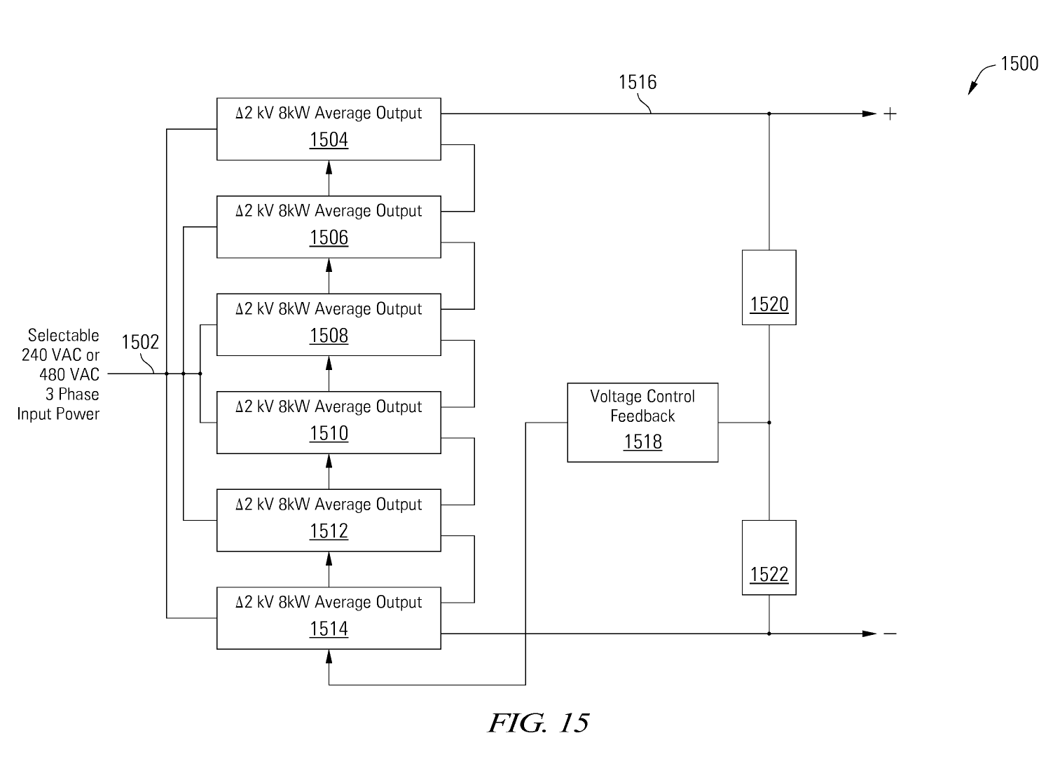

Turning to FIG. 15, a power conversion system 1500 with stackable switching modules and voltage control feedback is depicted in accordance with some embodiments of the invention, illustrating a selectable 240 VAC or 480 VAC 3 phase power input 1502 processed by an example array of six switching transformer modules 1504, 1506, 1508, 1510, 1512, 1514, having either internal full wave rectification or (not shown) external full wave rectification, each of 2 kV 8 kW average output to yield a 12 kV output 1516. In some embodiments, the inputs and outputs are floating. A voltage control feedback 1518 measures output voltage through divider resistors 1520, 1522 or other devices to perform output voltage control, fault detection, etc.

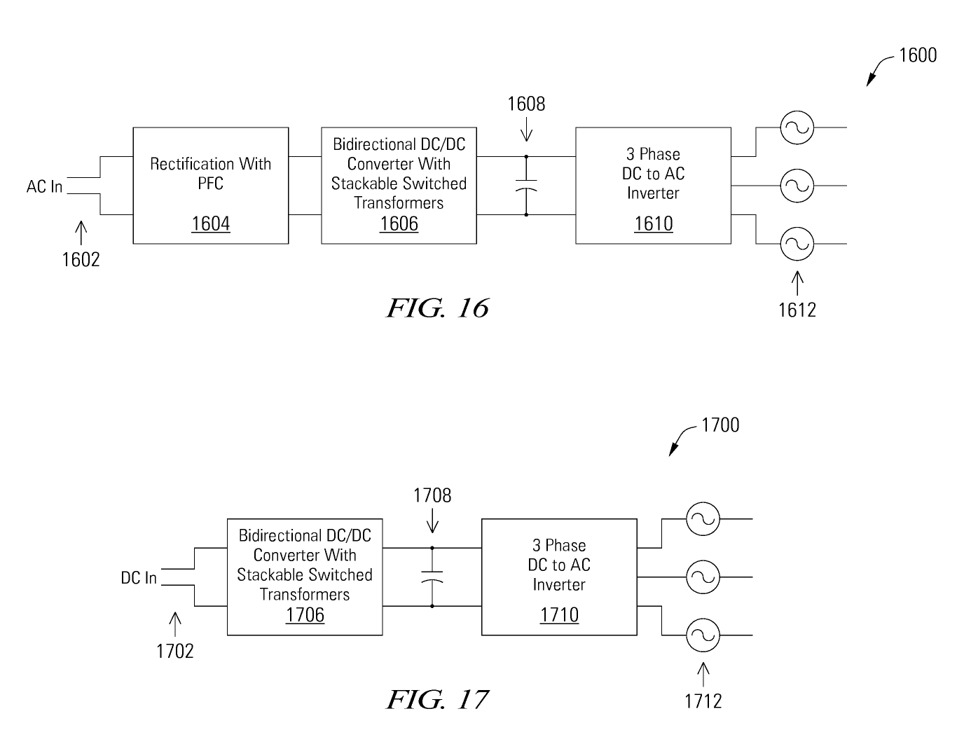

Turning to FIG. 16, a block diagram of an AC input power conversion system 1600 with 3 phase AC output is depicted in accordance with some embodiments of the invention. An AC input 1602 is rectified by a bidirectional DC to DC converter with stackable switched transformers 1606 having either internal full wave rectification or (shown) external full wave rectification with power factor correction if the input is AC. A high voltage DC link 1608 from the DC to DC converter with stackable switched transformers 1606 feeds a 3 phase DC to AC inverter 1610 to yield a 3 phase AC output 1612.

Turning to FIG. 17, a block diagram of a DC input power conversion system 1700 with 3 phase AC output is depicted in accordance with some embodiments of the invention. In this embodiment, a DC input 1702 is connected to a bidirectional DC to DC converter with stackable switched transformers 1706. A high voltage DC link 1708 from the DC to DC converter with stackable switched transformers 1706 feeds a 3 phase DC to AC inverter 1710 to yield a 3 phase AC output 1712.

In some embodiments of the present invention 3 phase DC to AC inverters 1610 and 1710 could also be single or two phase and also could be bidirectional. As a non-limiting example of one approach for 3 phase DC to AC inverters 1610 and 170 to be bidirectional, a dual full bridge bidirectional stage can be employed including for 1 to N phases where N>1.

In some embodiments, the power conversion system includes single phase AC to AC transformers referred to herein as a solid state transformer (SST) in which there is one switching network to convert the source AC (50 or 60 Hz) voltage to a high frequency AC voltage via the first switching network which is then converted back to the 50 or 60 Hz via a second switching network which converts the high frequency voltage back to grid frequency. Bi-directional power flow can be accomplished using symmetrical dual active H-bridge configurations. Since the input and output voltages are AC, the switches in an SST are configured to block voltages with both polarities, and the switches are configured to conduct current in both directions to realize bi-directional power flow. Therefore, each four-quadrant switch cell is constructed of two anti-serial connected GaN-based FET modules. A resonant capacitor is connected in parallel with each switch cell to facilitate soft switching as needed or desired. The circuit configuration of the AC-AC converter is controlled by phase-shift modulation (PSM).

Conversion/inversion schemes, topologies, approaches and requirements can include, but are not limited to, voltage-fed and current-fed/mode forward converters, push-pull, half bridge, full bridge, etc., related circuit topologies. Different embodiments of the present invention can have high frequency transformers have N turns ratios of 1:1 and 1:N and, in certain cases, N:1 where N>1.

The power, control and feedback circuits can include enhanced control schemes with both fast and slow time constants to keep the voltage as constant as possible under all operating conditions including at the onset, during and after transient changes. Push-pull and forward converter, half- and full-bridge, flyback for both current-mode and current-fed topologies can be used with the present invention. AC to DC design and associated switching module topology include but are not limited to size, weight, shape, form, etc. of the overall grid-tied system and allow of modular design and ease of replacement plug-in boards, modules, assemblies, etc.

The present invention also provides for extensive power supply system detection and protection.

The control feedback loops can include feedforward control loops, arc detect and protection. The present invention can also include start-up circuits, PWM, push-pull, half- and full-bridge, high-side/low-side, synchronous rectifier, charge pumps, bootstrapping, charge transfer, charge storage, etc. control circuits, etc.

Wired and wireless control, monitoring and data logging of the power converters and inverters including thermal monitoring, control and management can include, for example but not limited to, dynamic wired (i.e., Ethernet and USB) and wireless (i.e. ZigBee, Zwave, Bluetooth, including Bluetooth Low Energy, ISM, IEEE 802, WiFi) monitoring and control systems.

The present invention allows for dynamic control on a cycle-by-cycle basis. Some embodiments of the power conversion system provide a command set for and support for remote control and monitoring, status and alarms and over-ride commands.

Embodiments of the present invention can accept either or both AC or DC input including more than one phase (i.e., 1 to M phases where M typically equals 3 or could be 2, 4, 6, any whole number, etc.). The present invention can also use synchronous rectifiers including synchronous rectifiers that use field effect transistors of any type and material. In the case of a DC input, implementations of the present invention that use synchronous rectification can turn on all of the synchronous rectifiers to, for example, improve and enhance efficiency. The present invention can be inherently high power factor and provide low total harmonic distortion (THD).

The transformers can be connected in parallel, series, combinations of parallel and series, in arrays, etc. and can be compact and small with any practically desired form factor. The transformers can use high voltage rated wire which, depending on the switching frequency, can be rather small diameter (fine) wire and support high voltage isolation. Toroid and various types of bobbin and core sets can be used in the construction of the transformers as well as cores and bobbins designed to reduce EMI. For example, but not limited to, core types include, but are not limited to in any way or form, low profile (e.g., EFD, EQ), compact size (e.g., PQ, RM, EP), adjustable inductance (e.g., RM, P-core), windings on a printed circuit board (PCB) (e.g., planar), common cores such as C, E, EI, EC and ER, PH, PM, PQ, etc. combinations of these, etc. as well as associated bobbins and other related parts, components, accessories, etc.

In some embodiments, circuits can be provided on switching module printed circuit boards and/or controller circuit boards, such as, but not limited to, power supply circuits, driver circuits, control circuits, monitoring circuits, reporting circuits, interface circuits, etc. In some embodiments, circuits can include sensors such as, but not limited to, temperature sensors/thermostats, cameras, thermal imaging arrays, etc. Such circuits, for example but not limited to, can be located inline or along side the present invention or at any other location.

In some other embodiments, each switching module or transformer array or even sub-array can be controlled and monitored as part of the present invention to provide safe and secure operation and power output that is designed and implemented to balance power consumption and energy savings with heat load and other thermal considerations to deliver energy efficient, adjustable power for health, entertainment, safety, emergency, security, protection, detection, monitoring, reporting, analytics, community well being, surveillance, monitoring, data transfer, tracking including tracking and counting by wireless devices including unique wireless devices such as cellular phones, tablets and other communications and mobile devices equipped with Bluetooth, WiFi, mobile cellular protocols and systems, including but not limited to 3G and/or 4G, broadband, satellite, etc., as well as combinations of these and others.

In some other embodiments, the present some implementations of the present invention utilize current output control with a regulator with, for example but not limited to, switching mode regulation. In this case, the regulator switches to effective/local ground (low voltage drop equals low power dissipation) or open (no current equals low power dissipation). In addition to the passive and active components mentioned previously, other protection and detection devices and components can be used with the present invention including but not limited to tranzorbs, transient voltage suppressors (TVSs), Varistors, metal oxide varistors (MOVs), surge absorbers, surge arrestors, and other transients detection and protection devices, thermistors or other thermal devices, fuses, resettable fuses, circuit breakers, solid-state circuit breakers and relays, other types of relays including mechanical relays and circuit breakers, etc.

In embodiments of the present invention that include or involve buck, buck-boost, boost, boost-buck, etc. inductors, one or more tagalong inductors such as those disclosed in U.S. patent application Ser. No. 13/674,072, filed Nov. 11, 2012 by Sadwick et al. for a “Dimmable LED Driver with Multiple Power Sources”, which is incorporated herein for all purposes, may be used and incorporated into embodiments of the present invention. Such tagalong inductors can be used, among other things and for example, to provide power and increase and enhance the efficiency of certain embodiments of the present invention. In addition, other methods including charge pumps, floating diode pumps, level shifters, pulse and other transformers, bootstrapping including bootstrap diodes, capacitors and circuits, floating gate drives, carrier drives, etc. can also be used with the present invention. The transformers can also have an extra auxiliary bias output to power the control, switching, and other electronics and circuits.

In some embodiments of the present invention, the modules and circuits that are contained within can be connected in parallel or in an antiparallel configuration with their respective polarities reversed in order to achieve the desired output phases, voltages, power handling, protection, current phasing, etc., and that in some embodiments the term bidirectional can refer to antiparallel configuration/operation of the switches, diodes and other related components.

Programmable soft start including being able to also have a soft short at turn-on which then allows the input voltage to rise to its running and operational level can also be included in various implementations and embodiments of the present invention.

Some embodiments of the present invention utilize high frequency diodes including high frequency diode bridges and/or synchronous transistor rectifier bridges and voltage to voltage and/or current to voltage conversion to transform the power source into a suitable form so as to be able to work with existing AC line input circuits and drivers. Some other embodiments of the present invention utilize high-frequency diodes and/or synchronous transistor rectifier bridges to transform the DC or AC input into an AC output or into a direct current (DC) format that can be used directly or with further current or voltage regulation to power and drive the output load. Some embodiments of the present invention us one or more antiparallel diodes across the switching and potentially other transistors to form a bidirectional switch thus allowing current conduction in both directions for bidirectional power flow as set and determined by the, for example, but not limited to, the controlled switching operation which can be performed, manually, automatically, algorithmically, preprogrammed, local or remote programmed, detected, sequenced, etc., combinations of these, etc.

In some embodiments of the present invention, snubber and/or clamp circuits may be used with the rectification stages (which, for example, could be diodes or transistors operating in a synchronous mode); such snubbers could typically include capacitors, resistors and/or diodes or be of a lossless type of snubber where the energy is recycled including using additional inductors or windings on inductors or be made of capacitors only or resistors only, etc. Such snubbers can be of benefit in reducing radiated emissions. Some embodiments of the present invention can use lossless snubbers. Embodiments of the present invention can be used to convert the low frequency (i.e., typically 50 or 60 Hz) AC line as well as higher frequency AC to an appropriate current or voltage to drive and power loads using either or both series or in some cases shunt regulation. Some other embodiments of the present invention combine one or more of these. Various implementations of the present invention can involve voltage or current forward converters and/or inverters, square-wave, sine-wave, resonant-wave, etc. that include, but are not limited to, push pull, half-bridge, full-bridge, square wave, sine wave, fly-back, resonant, synchronous, linear regulation, buck, buck-boost, boost-buck, boost, etc.

For the present invention, in general, any type of transistor or vacuum tube or other similarly functioning device can be used including, but not limited to, MOSFETs, JFETs, GANFETs, depletion or enhancement FETs, N and/or P FETs, CMOS, NPN and/or PNP BJTs including Darlington transistors, triodes, tetrodes, pentodes, etc. which can be made of any suitable material in homojunction, heterojunction, combinations of these, etc. and configured to function and operate to provide the performance, for example, described above. In addition, other types of devices and components can be used including, but not limited to transformers, transformers of any suitable type and form, coils, level shifters, digital logic, analog circuits, analog and digital, mixed signals, microprocessors, microcontrollers, FPGAs, CLDs, PLDs, comparators, op amps, instrumentation amplifiers, and other analog and digital components, circuits, electronics, systems etc. For all of the example figures shown, the above analog and/or digital components, circuits, electronics, systems etc. are, in general, applicable and usable in and for the present invention.

The example drawings and embodiments shown are merely intended to provide some illustrations of the present invention and not limiting in any way or form for the present invention.

In addition to these examples, a potentiometer or similar device such as a variable resistor may be used to control the output level. Such a potentiometer may be connected across a voltage such that the wiper of the potentiometer can swing from minimum voltage to maximum voltage. Often the minimum voltage will be zero volts which may correspond to full off and, for the example embodiments shown here, the maximum will be equal to or approximately equal to the maximum level. In addition wireless control including duty cycle and associated control may be used to, for example, set the reference current setpoint used, for example, to control the current and/or voltage supplied to the load, etc.

Current sense methods including resistors, current transformers, current coils and windings, etc. can be used to measure and monitor the current of the present invention and provide both monitoring and protection.

In addition the present invention can support, for example, overcurrent, overvoltage, short circuit, and over-temperature protection. The present invention can also measure and monitor electrical parameters including, but not limited to, input (and/or output) current, input voltage, power factor, apparent power, real power, inrush current, harmonic distortion, total harmonic distortion, power consumed, watthours (WH) or killowatt hours (kWH), etc. of the load or loads connected to the present invention. In addition, in certain configurations and embodiments, some or all of the output electrical parameters may also be monitored and/or controlled directly for, for example, the load and even the output of the load should, for example, but not limited to, the load being a grid connection, power supply or supplies or drivers for lighting, heating, cooling, air conditioners, HVAC in general, motors, entertainment including televisions, computers, stereos, radios, DVD players, etc. and, in general, all other types of power consumers. Such output parameters can include, but are not limited to, output current, output voltage, output power, duty cycle, PWM, MPPT, dimming or level(s), etc.

In place of a potentiometer as a control device, an encoder or decoder can be used. The use of such also permits digital signals to be used and allows digital signals to either or both locally or remotely control the output level and state. A potentiometer with an analog to digital converter (ADC) or converters (ADCs) could also be used in many of such implementations of the present invention.

In addition to the examples above and any combinations of the above examples, the present invention can have multiple output levels set by control interface(s) in conjunction with sensors such as, but not limited to, motion sensors and photosensor/photodetector and/or other control and monitoring inputs including, but not limited to, analog (e.g., 0 to 10 V, 0 to 3 V, etc.), digital (RS232, RS485, USB, DMX, SPI, SPC, UART, other serial interfaces, etc.), a combination of analog and digital, analog-to-digital converters and interfaces, digital-to-analog converters and interfaces, wired, wireless (i.e., RF, WiFi, ZigBee, Zwave, ISM bands, 2.4 GHz, etc.), powerline (PLC) including X-10, Insteon, HomePlug, etc.), Bluetooth, Bluetooth Low Energy, RFID, Ethernet, power over Ethernet, (POE), combinations of these, others, etc.

The present invention is highly configurable and words such as current, set, specified, etc. when referring to, for example, the output level or levels, may have similar meanings and intent or may refer to different conditions, situations, etc. For example, in a simple case, the current level may refer to the reference level set by, for example, a control voltage from a digital or analog source including, but not limited to digital signals, digital to analog converters (DACs), potentiometer(s), encoders, etc.

The present invention can have embodiments and implementations that include manual, automatic, monitored, controlled operations and combinations of these operations. The present invention can have switches, knobs, variable resistors, encoders, decoders, push buttons, scrolling displays, cursors, etc. The present invention can use analog and digital circuits, a combination of analog and digital circuits, microcontrollers and/or microprocessors including, for example, DSP versions, FPGAs, CLDs, ASICs, etc. and associated components including, but not limited to, static, dynamic and/or non-volatile memory, a combination and any combinations of analog and digital, microcontrollers, microprocessors, FPGAs, CLDs, etc. Items such as motion sensor(s), photodetector(s)/photosensor(s), microcontrollers, microprocessors, controls, displays, knobs, etc. may be internally located and integrated/incorporated into the power conversion system or externally located. The switches/switching elements can consist of any type of semiconductor and/or vacuum technology including but not limited to triacs, transistors, vacuum tubes, triodes, diodes or any type and configuration, pentodes, tetrodes, thyristors, silicon controlled rectifiers, diodes, etc. The transistors can be of any type(s) and any material(s)—examples of which are listed below and elsewhere in this document.

The present invention may use and be configured in continuous conduction mode (CCM), critical conduction mode (CRM), discontinuous conduction mode (DCM), resonant conduction modes, etc., with any type of circuit topology including but not limited to buck, boost, buck-boost, boost-buck, cuk, SEPIC, flyback, half bridges, full bridges, forward-converters, linear regulators, etc., any or all of which can be bidirectional. The present invention works with both isolated and non-isolated designs including, but not limited to, buck, boost-buck, buck-boost, boost, cuk, SEPIC, flyback and forward-converters. The present invention itself may also be non-isolated or isolated, for example using a tagalong inductor or transformer winding or other isolating techniques, including, but not limited to, transformers including signal, gate, isolation, etc. transformers, optoisolators, optocouplers, etc.

The present invention may include other implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. Portions of the present invention can be incorporated into an integrated circuit, be an integrated circuit, etc.

The present invention can also incorporate at an appropriate location or locations one or more thermistors (i.e., either of a negative temperature coefficient [NTC] or a positive temperature coefficient [PTC]) to provide temperature-based load current limiting.

The present invention also supports overrides including manual, automatic and programmed overrides as desired or needed. The present invention can also include circuit breakers including solid state circuit breakers and other devices, circuits, systems, etc. that limit or trip in the event of an overload condition/situation. The present invention can also include, for example analog or digital controls including but not limited to wired (i.e., 0 to 10 V, RS 232, RS485, IEEE standards, SPI, I2C, other serial and parallel standards and interfaces, etc.), wireless, powerline, etc. and can be implemented in any part of the circuit for the present invention. The present invention can be used with a buck, a buck-boost, a boost-buck and/or a boost, flyback, or forward-converter design, topology, implementation, etc.

Other embodiments can use comparators, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices, field programmable gate arrays, etc.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. Again portions of the present invention can be incorporated into an integrated circuit, be an integrated circuit, be an application specific integrated circuit (ASIC), etc.

The present invention includes embodiments that have autonomous motion and light/photodetection control, and can and may also use other types of stimuli, input, detection, feedback, response, etc. including but not limited to sound, voice, voice control, motion, gesturing, vibration, frequencies above and below the typical human hearing range, temperature, humidity, pressure, light including below the visible (i.e., infrared, IR) and above the visible (i.e., ultraviolet, UV), radio frequency signals, combinations of these, etc. For example, the motion sensor may be replaced or augmented with a sound sensor (including broad, narrow, notch, tuned, tank, etc. frequency response sound sensors), a voice sensor and/or detector, voice recognition, and the light sensor could consist of one or more of the following: visible, IR, UV, etc., sensors. In addition, the light sensor(s)/detector(s) can also be replaced or augmented by thermal detector(s)/sensor(s), etc.

The example embodiments disclosed herein illustrate certain features of the present invention and not limiting in any way, form or function of present invention. The present invention is, likewise, not limited in materials choices including semiconductor materials such as, but not limited to, silicon (Si), silicon carbide (SiC), silicon on insulator (SOD, other silicon combination and alloys such as silicon germanium (SiGe), etc., diamond, graphene, gallium nitride (GaN) and GaN-based materials, gallium arsenide (GaAs) and GaAs-based materials, diamond and diamond-based materials, etc. The present invention can include any type of switching elements including, but not limited to, field effect transistors (FETs) of any type such as metal oxide semiconductor field effect transistors (MOSFETs) including either p-channel or n-channel MOSFETs of any type, junction field effect transistors (JFETs) of any type, metal emitter semiconductor field effect transistors, etc. again, either p-channel or n-channel or both, bipolar junction transistors (BJTs) again, either NPN or PNP or both including, but not limited to, Darlington transistors, heterojunction bipolar transistors (HBTs) of any type, high electron mobility transistors (HEMTs) of any type, unijunction transistors of any type, modulation doped field effect transistors (MODFETs) of any type, etc., again, in general, n-channel or p-channel or both, vacuum tubes including diodes, triodes, tetrodes, pentodes, etc. and any other type of switch, etc.

While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A power conversion system comprising:
a power input;
a power output; and
a plurality of stackable power conversion modules having inputs connected to the power input and outputs connected to the power output, each comprising a transformer switched at a higher frequency than a grid frequency.

2. The power conversion system of claim 1, wherein at least some of the plurality of stackable power conversion modules are connected in series.

3. The power conversion system of claim 1, wherein at least some of the plurality of stackable power conversion modules are connected in parallel.
